(19) United States
(12) Patent Application Publication
(10) Pub. No.: US 2026/0059194 A1
(43) Pub. Date: Feb. 26, 2026

(54) ELECTRONIC DEVICE AND VIDEO MANAGEMENT METHOD

(71) Applicant: Panasonic Intellectual Property Management Co., Ltd., Osaka (JP)

(72) Inventors: Shohei KINUTA, Osaka (JP); Toshinari SUO, Osaka (JP); Takayoshi SHIMODA, Osaka (JP)

(73) Assignee: Panasonic Intellectual Property Management Co., Ltd., Osaka (JP)

(21) Appl. No.: 19/301,946

(22) Filed: Aug. 16, 2025

(30) Foreign Application Priority Data
Aug. 22, 2024 (JP) 2024-140939

(51) Int. Cl. H04N 23/661; G06F 3/0482; H04N 21/472

(52) U.S. Cl. CPC H04N 23/661; G06F 3/0482; H04N 21/47217

(57) ABSTRACT

An electronic device for managing video shooting including a plurality of cuts, including: a display that displays information on the video shooting including the plurality of sections; an input interface that inputs a user operation; and a controller that controls the display according to the user operation input on the input interface. After a video associated with a first section of the plurality of sections is shot, the controller changes an associated section into a second section from the first section, according to the user operation on the input interface, the associated section being associated the shot video, the second section being different from the first section.

### TECHNICAL FIELD

The present disclosure relates to an electronic device and a video management method for managing video shooting in a scenario including a plurality of sections such as cuts.

### BACKGROUND ART

JP 2004-187275 A discloses a video program creation support system that can consistently use a scenario in an electronic file format from a planning construction stage to an editing stage. The video program creation support system includes an imaging apparatus that creates take metadata in configuration table metadata for each take and associates content data of the take and the take metadata with a cut in the program metadata. In this imaging apparatus, when only one take is associated with the selected cut at the end of imaging of the cut, this take is automatically set to OK (adopted). On the other hand, when a plurality of takes are associated with the cut, one take is set to OK and the other takes are set to NG (not adopted) on the basis of the OK/NG selection operation of the camera operator.

### SUMMARY

The present disclosure provides an electronic device and a video management method capable of reducing management errors using a plurality of sections in video shooting.

In the present disclosure, an electronic device, for managing video shooting including a plurality of cuts, includes: a display that displays information on the video shooting including the plurality of sections; an input interface that inputs a user operation; and a controller that controls the display according to the user operation input on the input interface. After a video associated with a first section of the plurality of sections is shot, the controller changes an associated section into a second section from the first section, according to the user operation on the input interface, the associated section being associated the shot video, the second section being different from the first section.

In the present disclosure, a video management method, for managing video shooting including a plurality of sections, includes: controlling, by a controller of an electronic device, shooting of a video in association with a first section of the plurality of sections; and changing, by the controller, an associated section into a second section from the first section according to a user operation on an input interface, after the video associated with the first section is shot, the associated section being associated the shot video, the second section being different from the first section.

According to the electronic device and the video management method of the present disclosure, it is possible to reduce management errors using the plurality of sections in video shooting.

### BRIEF DESCRIPTION OF DRAWINGS

FIG. 1 is a diagram illustrating a configuration of an imaging system according to a first embodiment of the present disclosure;

FIG. 2 is a diagram illustrating a configuration of a digital camera in the imaging system;

FIG. 3 is a diagram illustrating a configuration of an information support terminal in the imaging system;

FIG. 4 is a diagram illustrating a display example of a function selection screen in the information support terminal;

FIG. 5A is a diagram illustrating a display example of a scenario input screen in the information support terminal;

FIG. 5B is a diagram illustrating a display example of a storyboard editing screen in the information support terminal;

FIG. 6 is a diagram illustrating a data structure of cut allocation data in the information support terminal;

FIG. 7 is a diagram illustrating a display example of a cut selection screen in the information support terminal;

FIG. 8 is a flowchart illustrating an operation of a cut shooting function in the imaging system;

FIG. 9 is a diagram illustrating a display example of a rating screen in the information support terminal;

FIG. 10 is a flowchart illustrating cut list generation processing in the imaging system;

FIG. 11 is a diagram for explaining filtering of a cut list;

FIG. 12 is a diagram illustrating a cut list in a case with an additional cut;

FIG. 13 is a flowchart illustrating recording mode processing in the imaging system;

FIGS. 14A to 14D are diagrams illustrating a display example in a recording mode of the information support terminal;

FIG. 15 is a diagram illustrating a data structure of video management data list in the information support terminal;

FIG. 16 is a flowchart illustrating playback mode processing in the imaging system;

FIGS. 17A to 17C are diagrams illustrating a display example in a playback mode of the information support terminal;

FIGS. 18A and 18B are diagrams for explaining details of a display example in the playback mode of the information support terminal;

FIG. 19 is a flowchart illustrating cut relocation processing in the information support terminal;

FIGS. 20A to 20D are diagrams illustrating a display example in the cut relocation processing of the information support terminal;

FIG. 21 is a diagram illustrating a display example of a video editing screen in a video editing PC of the imaging system;

FIGS. 22A to 22C are diagrams for explaining automatic detection processing in an imaging system of a second embodiment;

FIG. 23 is a flowchart illustrating automatic detection processing in the imaging system of the second embodiment;

FIG. 24 is a diagram illustrating a display example of an alert of a cut error in the imaging system of the second embodiment; and

FIG. 25 is a diagram for explaining a modification of the digital camera.

### DETAILED DESCRIPTION

Embodiments will be described in detail below with reference to the drawings as appropriate. However, detailed description of already well-known matters and redundant description of substantially the same configuration may be omitted. Note that the accompanying drawings and the following description are provided for those skilled in the art to fully understand the present disclosure, and are not intended to limit the subject matter described in the claims.

### First Embodiment

In a first embodiment of the present disclosure, a system using an electronic device separate from an imaging apparatus that executes video shooting will be described.

### 1. Configuration

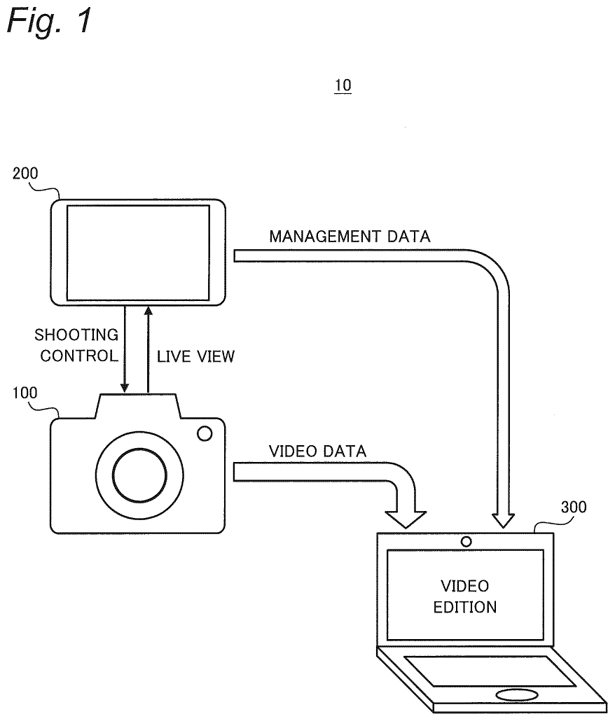

An imaging system according to the first embodiment of the present disclosure will be described with reference to FIG. 1.

For example, as illustrated in FIG. 1, a system 10 includes a digital camera 100, an information support terminal 200, and a video editing personal computer (PC) 300. In the present system 10, the digital camera 100 and the information support terminal 200 are data-communicably connected by wired communication or wireless communication, for example.

The present system 10 is applicable to a user creating a desired video work by shooting and editing a plurality of videos with the digital camera 100, for example. For example, the present system 10 provides information support useful for a series of workflows in which a user plans a scenario indicating a concept of a video work, repeatedly shoot a video according to a plurality of cuts that are divided from the scenario, and edits a plurality of shot videos.

In the present system 10, the information support terminal 200 can manage a scenario of a video work, and control the digital camera 100 so as to manage video shooting for each cut, for example. For example, a live view image in the digital camera 100 can be viewed on the information support terminal 200. The video data of the shooting result of the digital camera 100 is edited in the video editing PC 300. The present system 10 uses data managed by the information support terminal 200 from the viewpoint of facilitating video editing in the video editing PC 300 and the like.

In the present system 10, the video editing PC 300 may or may not be communicably connected to one or both of the digital camera 100 and the information support terminal 200. For example, data from the digital camera 100 and/or the information support terminal 200 may be input to the video editing PC 300 via a portable recording medium such as a memory card. The present system 10 may not include the video editing PC 300.

### 1.1. Configuration of Digital Camera

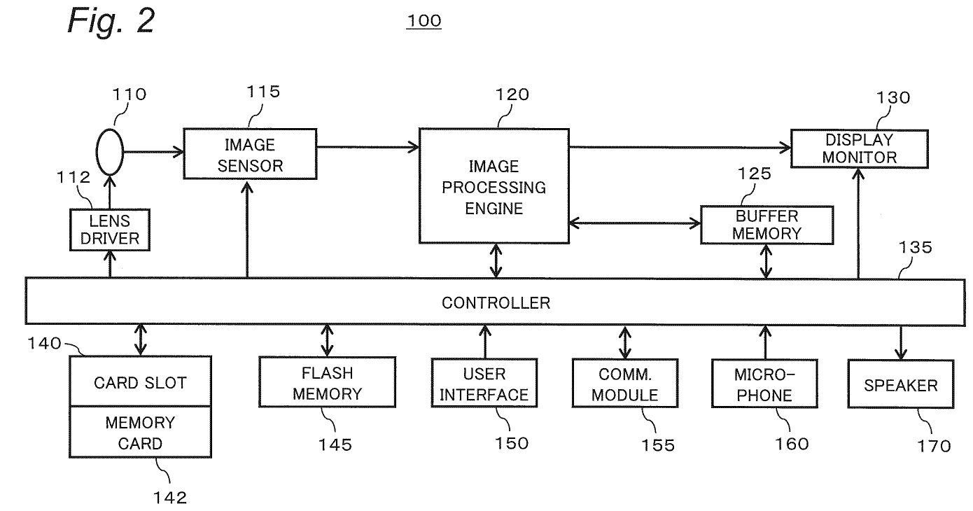

A configuration of the digital camera 100 in the present embodiment will be described with reference to FIG. 2.

FIG. 2 is a diagram illustrating the configuration of the digital camera 100 in the present system 10. The digital camera 100 is an example of an imaging apparatus in the present embodiment. The digital camera 100 according to the present embodiment includes an image sensor 115, an image processing engine 120, a display monitor 130, and a controller 135. Further, the digital camera 100 includes a buffer memory 125, a card slot 140, a flash memory 145, a user interface 150, a communication module 155, a microphone 160, and a speaker 170. Furthermore, the digital camera 100 includes an optical system 110 and a lens driver 112, for example.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like includes one lens or more lenses.

The lens driver 112 drives the focus lens and the like in the optical system 110. The lens driver 112 includes a motor, to move the focus lens along the optical axis of the optical system 110 under the control of the controller 135. The configuration for driving the focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 performs an operation of capturing a still image, an operation of capturing a through image, and the like. The through image is mainly a video, and is displayed on the display monitor 130 in order for the user to determine a composition for capturing a still image. Each of the through image and the still image is an example of a captured image in the present embodiment. The image sensor 115 is an example of an imager in the present embodiment.

The image processing engine 120 performs various processing on the imaging data output from the image sensor 115 to generate image data, and performs various processing on the image data to generate an image to be displayed on the display monitor 130. Examples of various processing include white balance correction, gamma correction, YC conversion processing, electronic zoom processing, compression processing, expansion processing, and the like, but the various processing are not limited thereto. The image processing engine 120 may be configured by a hard-wired electronic circuit, or may be configured by a microcomputer using a program, a processor, or the like.

The display monitor 130 is an example of a display that displays various information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be configured by a liquid crystal display device or an organic EL device, for example.

The user interface 150 is a general term for hard keys such as operation buttons and operation levers provided on the exterior of the digital camera 100, operable to receive an operation by the user. For example, the user interface 150 includes a release button, a mode dial, and a touch panel. When the user interface 150 receives an operation by the user, the user interface 150 transmits an operation signal corresponding to the user operation to the controller 135.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Although not illustrated, the controller 135 may include various internal memories, and may incorporate a ROM, for example. The ROM stores various programs to be executed by the controller 135. The controller 135 may incorporate a RAM that functions as a work area of the CPU.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155. The microphone 160 includes one or more microphone elements incorporated in the digital camera 100, for example. The microphone 160 outputs a sound signal indicating the collected sound to the controller 135. An external microphone may be used in the digital camera 100. The digital camera 100 may include a connector such as a terminal connected to an external microphone instead of or in addition to the built-in microphone 160.

The speaker 170 includes one or more speaker elements built in the digital camera 100 and outputs sound to the outside of the digital camera 100 under the control of the controller 135, for example. In the digital camera 100, an external speaker, an earphone, or the like may be used. The digital camera 100 may include a connector connected to an external speaker or the like instead of or in addition to the built-in speaker 170.

### 1.2. Configuration of Information Support Terminal

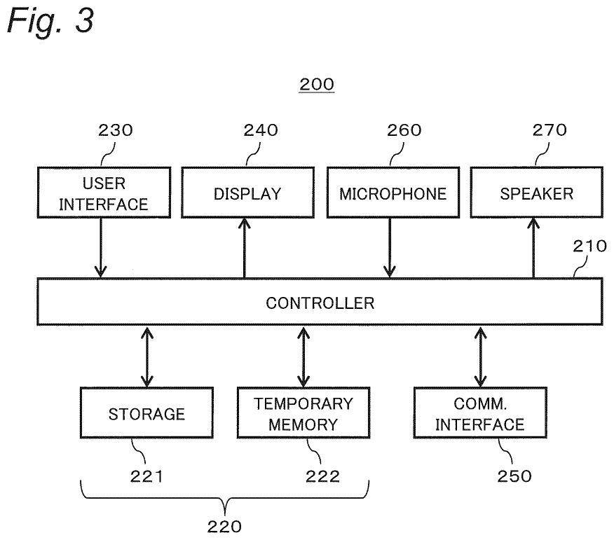

A configuration of the information support terminal 200 in the present embodiment will be described with reference to FIG. 3.

FIG. 3 is a diagram illustrating the configuration of the information support terminal 200. The information support terminal 200 is an example of an electronic device including a smartphone, a tablet terminal, a PC, or the like, for example. The information support terminal 200 illustrated in FIG. 3 includes a controller 210, a memory 220, a user interface 230, a display 240, a communication interface 250, a microphone 260, and a speaker 270.

The controller 210 includes a CPU or an MPU that realizes a predetermined function in cooperation with software, for example. The controller 210 controls the overall operation of the information support terminal 200, for example. The controller 210 reads data and programs stored in the memory 220 and performs various calculation processing to realize various functions.

For example, the controller 210 executes a program including a command group for realizing each of the above-described functions. The above program may be provided from a communication network such as the Internet, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a memory medium that stores programs and data necessary for implementing the functions of the information support terminal 200. As illustrated in FIG. 3, the memory 220 includes a storage 221 and a temporary memory 222.

The storage 221 stores parameters, data, control programs, and the like for realizing a predetermined function. The storage 221 includes an HDD or an SSD, for example. For example, the storage 221 stores the above-described programs, various image data, and the like.

The temporary memory 222 includes a RAM such as a DRAM or an SRAM, to temporarily store (i.e., hold) data, for example. For example, the temporary memory 222 holds image data in the middle of being edited. In addition, the temporary memory 222 may function as a work area of the controller 210, and may be configured by a storage area in an internal memory of the controller 210.

The user interface 230 is a general term for operation members operated by a user. For example, the user interface 230 is a touch panel superimposed on the display 240 to input various touch operations, and is an example of an input interface of the information support terminal 200. The input interface may be a connection software unit that is communicably connected to various external input devices and receives an operation signal. The user interface 230 may be a physical button, a switch, or the like provided in the information support terminal 200, or a keyboard, a mouse, a touch pad, or the like may be used. The user interface 230 may be various GUIs such as virtual buttons and icons, cursors, software keyboards, and objects displayed on the display 240.

The display 240 includes a liquid crystal display or an organic EL display, for example. The display 240 may display various information such as various GUIs for operating the user interface 230 and information input from the user interface 230.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the information support terminal 200 to a communication network such as the Internet. The communication interface 250 is an example of an input interface that receives various information from an external device or a communication network.

The microphone 260 includes one or more microphone elements incorporated in the information support terminal 200, for example. The microphone 260 outputs a sound signal indicating the collected sound to the controller 210. The information support terminal 200 may include a connector such as a terminal connected to an external microphone instead of or in addition to the built-in microphone 260.

The speaker 270 includes one or more speaker elements built in the digital camera 100, and outputs a sound to the outside of the information support terminal 200 under the control of the controller 210, for example. The information support terminal 200 may include a connector connected to an external speaker, an earphone, or the like instead of or in addition to the built-in speaker 270.

The configuration of the information support terminal 200 as described above is an example, and the configuration of the information support terminal 200 is not limited thereto. For example, various display devices such as a projector and a head mounted display may be used as the display 240 of the information support terminal 200. For example, when an external display device is used, the display 240 of the information support terminal 200 may be an output interface circuit such as a video signal conforming to the HDMI standard or the like.

### 2. Operation

The operation of the present system 10 configured as described above will be described below.

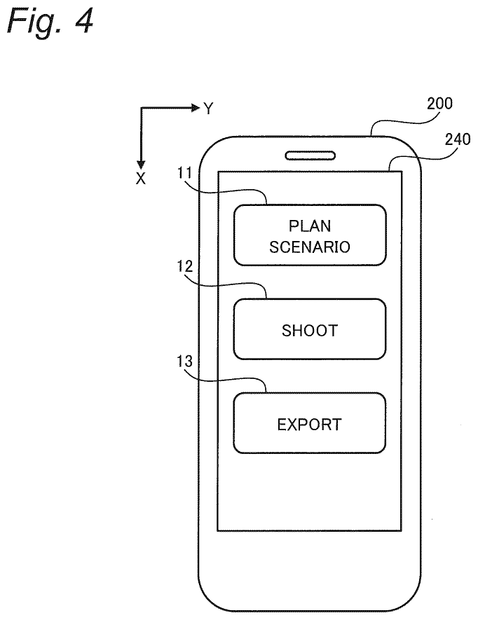

In the present system 10, the information support terminal 200 has various functions for sequentially providing information support to the user in the workflow of video production. A display example of a screen for selecting various functions of the information support terminal 200 is illustrated in FIG. 4.

The display 240 of the information support terminal 200 displays a scenario planning button 11, a shooting button 12, and an export button 13 on the function selection screen illustrated in FIG. 4. Hereinafter, the longitudinal direction on the screen of the display 240 is defined as an X direction, and the width direction is defined as a Y direction.

The scenario planning button 11 is a virtual button that responds a user operation to execute a function (i.e., a scenario planning function) of performing information support for a process of planning a scenario by the user before shooting a video in the present system 10. The information support terminal 200 of the present system 10 manages various information for each cut such as a shooting section that divides the scenario planned in this way. The cut constitutes a section in a plurality of times of video shooting for a scenario, for example.

For example, the shooting button 12 is a virtual button for executing a function (i.e., a cut shooting function) of supporting video shooting of each cut in a scenario planned by the scenario planning function. The number of times of shooting a video for one cut is not particularly limited to one take, and may be a plurality of takes. In the present embodiment, the information support terminal 200 controls video shooting by the digital camera 100 in the cut shooting function, and manages an shooting result for each cut.

The export button 13 is a virtual button for executing a function (i.e., an export function) of performing pre-processing for external output on a management result of video shooting by the cut shooting function and outputting the result. The pre-processing by the export function provides information support for facilitating a process of editing a video of a plurality of shooting results according to a scenario in the video editing PC 300, for example.

The information support terminal 200 of the present system 10 can provide comprehensive information support from planning of a scenario to pre-processing of video editing when the user sequentially uses the functions of the scenario planning button 11, the shooting button 12, and the export button 13, for example.

In the present system 10, the function selection screen of the information support terminal 200 may further include a delete button for deleting various data in the information support as described above. For example, the information support terminal 200 may collectively delete the video files of the same scenario in response to the user operation of the delete button.

### 2.1. Scenario Planning Function

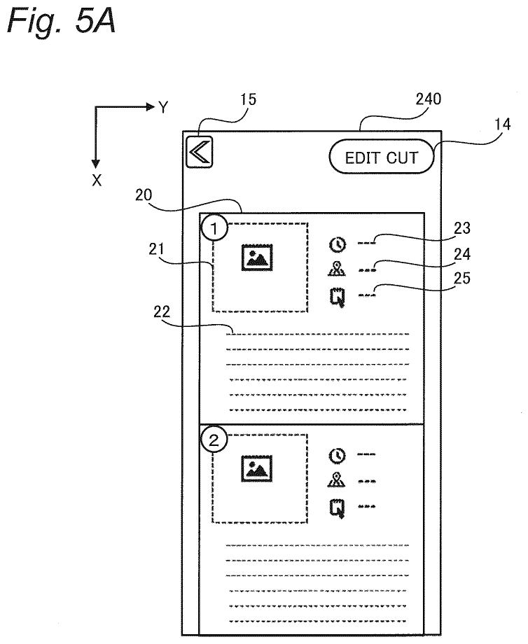

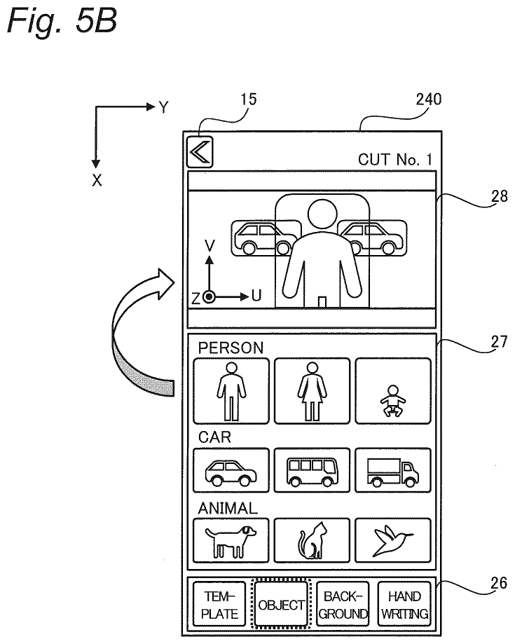

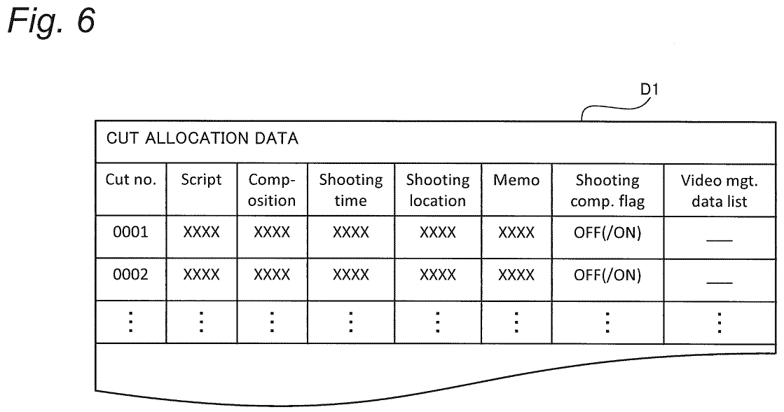

The scenario planning function in the information support terminal 200 of the present system 10 will be described with reference to FIGS. 5A to 6.

FIG. 5A illustrates a display example of a scenario input screen in the information support terminal 200. When a user operation such as tapping the scenario planning button 11 on the function selection screen of FIG. 4 is input from the user interface 230, the controller 210 of the information support terminal 200 displays a scenario input screen on the display 240 as illustrated in FIG. 5A.

The scenario input screen is a screen for the user to input a scenario to the information support terminal 200 in the scenario planning function of the present system 10. As illustrated in FIG. 5A the scenario input screen includes a storyboard input field 20 for each cut, a cut edit button 14, and a return button 15, for example. The controller 210 of the information support terminal 200 causes the user interface 230 to receive various user operations related to the scenario input screen displayed on the display 240.

In the information support terminal 200, the storyboard input field 20 receives a user input of information indicating a storyboard such as an outline of a scenario concept for each cut constituting a scenario. As illustrated in FIG. 5A, the storyboard input field 20 for each cut includes a composition field 21, a script field 22, a shooting time field 23, a shooting location field 24, and a memo field 25, for example.

The composition field 21 receives an input of composition information indicating a composition or the like in the video shooting of the cut. FIG. 5B illustrates a storyboard editing screen for editing the composition for each cut.

The storyboard editing screen illustrated in FIG. 5B includes an editing method selection field 26, an object selection field 27, an object arrangement field 28, and a return button 15. For example, the storyboard editing screen of FIG. 5B is displayed by selecting the editing method “object” in the editing method selection field 26 after a tap operation on the composition field 21 of the cut to be edited or selection of the corresponding menu in the scenario input screen of FIG. 5A.

For example, the editing method “object” is a method in which the user selects an object indicating a subject presumed for each cut from the object selection field 27 and arranges the selected object in a desired composition in the object arrangement field 28, thereby editing composition information of the storyboard for each cut.

The object selection field 27 includes options of objects for each type. The type of the object may be a category such as “person”, “car”, or “animal”, or may be a sub-category subdivided for each category.

The object arrangement field 28 manages spatial coordinates (U, V, Z) at which an object is arranged. For example, the spatial coordinates (U, V, Z) in the object arrangement field 28 include two-dimensional coordinates (U, V) corresponding to the field angle range of the video and a depth coordinate Z of the subject. The management of the depth coordinate Z is performed according to an overlap between arranged objects or a size of an object, for example.

In the example of FIG. 5B, in the object arrangement field 28, one object of the type “person” and two objects of the type “car” are arranged on the near side and the far side in the depth direction (Z), respectively. In this method, the composition information of the storyboard for each cut is object information including a positional relation such as the type, number, and spatial coordinates (U, V, Z) of the objects, for example.

In the present system 10, the composition information is not particularly limited to the above example, and may be image information, for example. The method of editing the composition information is not limited to the above example, and may be, e.g., as illustrated in a selection field 26 of FIG. 5B, “template” from which a template of a composition prepared in advance can be selected, “background” from which a background can be selected, or “handwriting” from which handwriting input can be performed. The input of the image information may be drawing by user operation or designation of image data. Each of the various composition information or the various information on the storyboard is an example of the subject information in the present embodiment.

Returning to FIG. 5A, the script field 22 receives a text input such as a script divided for the cut in the scenario.

The shooting time field 23 receives a numerical value input indicating a rough time length for shooting the video of the cut. The shooting location field 24 receives an input of information indicating a location where the video of the cut is shot. The input of the shooting location may be text input, or data search or the like may be appropriately used. The memo field 25 receives an input of various information desired by the user, such as shooting equipment, with respect to the video shooting of the cut by text input, for example.

In the example of FIG. 5A, the display 240 displays a storyboard input field 20 for two cuts. The controller 210 acquires the storyboard information for each cut according to the user input to the various fields 21 to 25 in the storyboard input field 20 for each cut in the scenario. On the scenario input screen of the information support terminal 200, the storyboard input field 20 of the cut displayed on the display 240 can be changed according to a swipe operation for scrolling in the X direction in which the storyboard input field 20 for each cut is arranged, for example.

The cut edit button 14 switches on/off of a state in which various user operations such as addition, deletion, and order change of cuts included in the scenario can be input. For example, by a touch operation in the on state of the cut edit button 14, the user can arrange the storyboard input fields 20 for a desired number of cuts in order in time series in the scenario.

The return button 15 responds a user operation to return the screen transition in the information support terminal 200 by one screen. For example, the controller 210 causes the display 240 to transition to the function selection screen (FIG. 4) in response to the user operation of the return button 15 on the scenario input screen (FIG. 5A). As an output of such a scenario planning function, the controller 210 according to the present embodiment generates cut allocation data including storyboard information of each cut and stores the cut allocation data in the memory 220. The cut allocation data at the end of such a scenario planning function is illustrated in FIG. 6.

For example, as illustrated in FIG. 6, cut allocation data D1 manages “script”, “composition”, “shooting time”, “shooting location”, “shooting completion flag”, and “video management data list” in association with each other for each “cut number”. The cut allocation data D1 is an example of management information in the present embodiment.

For example, the controller 210 of the information support terminal 200 assigns cut numbers indicating cut identification information in the cut allocation data D1 in ascending order in the storyboard input field 20 for each cut arranged on the scenario input screen. When the cut order is changed, the controller 210 re-assigns the cut numbers according to the changed order. For each cut, the controller 210 records each piece of information input to the script field 22, the composition field 21, the shooting time field 23, the shooting location field 24, and the memo field 25 of the storyboard input field 20 in “script”, “composition”, “shooting time”, “shooting location”, and “memo” of the cut allocation data D1, respectively.

In the cut allocation data D1, the “shooting completion flag” manages whether the cut is in a state of imaging completion or in a state of imaging incompletion by ON/OFF. At the end of the scenario planning function, the shooting completion flag is set to OFF for all cuts as an initial setting.

The “video management data list” is a list for storing management data of a video shot in association with the cut. The video management data may be metadata of the video. At the end of the scenario planning function, the video management data list is set to an empty value as an initial setting.

As described above, according to the scenario planning function in the information support terminal 200 of the present system 10, by generating the cut allocation data D1 from the user input on the scenario input screen, the information support of the process of planning the scenario of the video work desired by the user for each cut can be performed.

The scenario planning function of the information support terminal 200 is not particularly limited to the above. For example, the information support terminal 200 may receive a user instruction for outputting data of the storyboard information of the scenario input on the scenario input screen using a data format (e.g., PDF format) that can be shared by another device, and perform the data output.

### 2.2. Cut Shooting Function

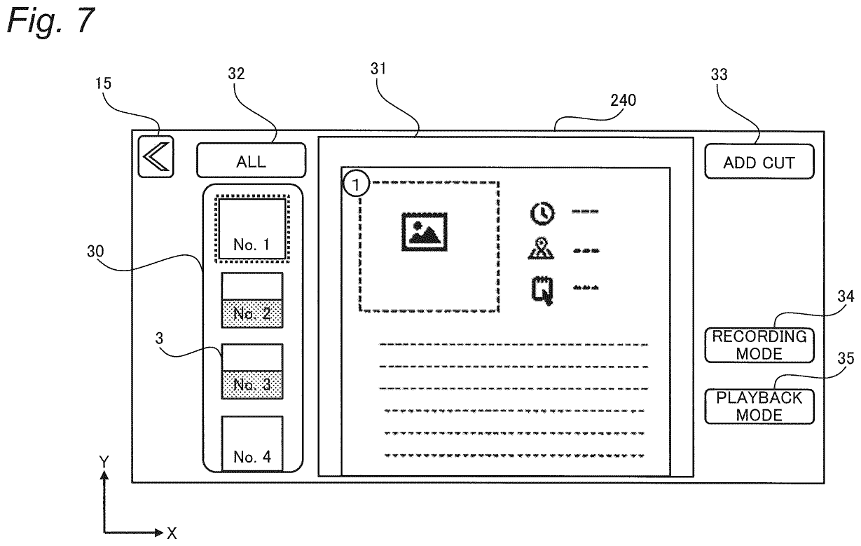

An outline of an operation of the cut shooting function in the information support terminal 200 of the present system 10 will be described with reference to FIG. 7.

FIG. 7 illustrates a display example of a cut selection screen on the information support terminal 200. The cut selection screen is a screen for selecting a cut desired by the user from cuts provided in the scenario planning function in the cut shooting function of the present system 10, for example. The cut selection screen is an example of a selection screen in the information support terminal 200 according to the present embodiment.

As illustrated in FIG. 7, the cut selection screen includes a cut list 30, a storyboard display field 31, a filter button 32, a cut addition button 33, a recording mode button 34, a playback mode button 35, and a return button 15, for example. The cut list 30 is a list listing various cuts as options selectable by the user. The storyboard display field 31 is a display field for displaying storyboard information on the selected cut. Details of the cut selection screen will be described later.

In the cut shooting function of the present system 10, the information support terminal 200 provides information support that facilitates the user to comprehensively carry out video shooting of each cut with checking various cuts, by using the cut selection screen illustrated in FIG. 7, for example. The user may perform video shooting in an order different from the cut order in the scenario, or may perform video shooting of a plurality of takes for video shooting of one cut.

Therefore, the information support terminal 200 of the present system 10 receives the rating by the user of the video for the selected cut at shooting the video of each take, manages whether or not the shooting of the cut is completed, and visualizes the progress status of the video shooting for each cut in the cut list 30 for the user. Details of the operation of the present system 10 will be described below.

### 2.2.1. Overall Operation of Cut Shooting Function

The overall operation of the cut shooting function in the present system 10 will be described with reference to FIGS. 7 to 9.

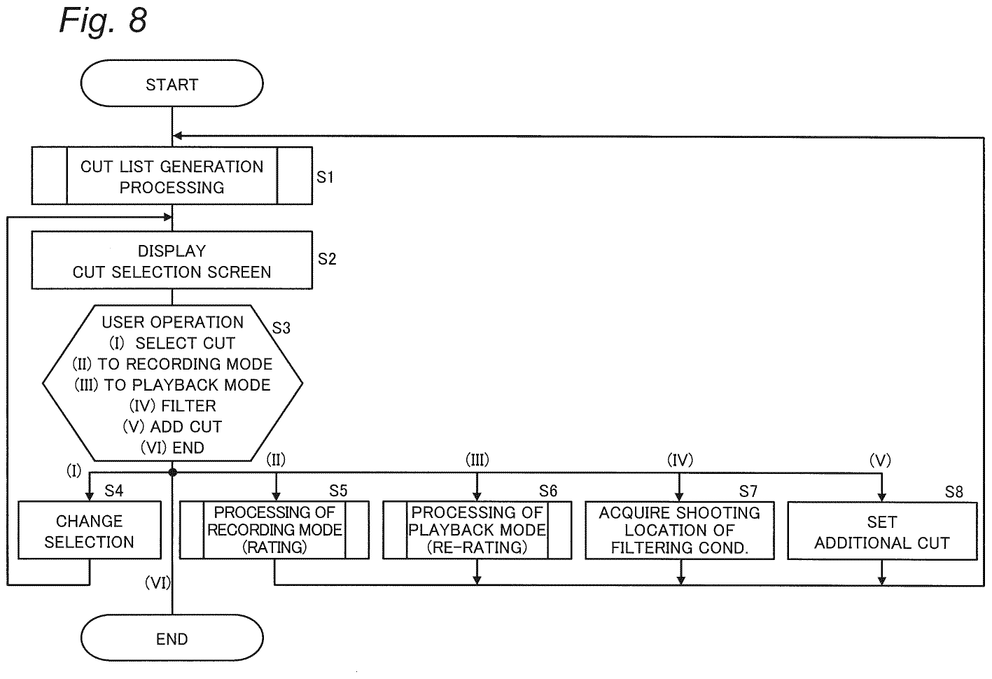

FIG. 8 is a flowchart illustrating an operation of the cut shooting function in the present system 10. Each processing illustrated in the flowchart of FIG. 8 is executed by the controller 210 of the information support terminal 200, for example. For example, the processing of this flow is started when the shooting button 12 on the function selection screen (FIG. 4) is operated in a state where the cut allocation data D1 by the scenario planning function is stored in the memory 220 and the communication connection with the digital camera 100 is established in the communication interface 250.

First, the controller 210 of the information support terminal 200 generates the cut list 30 to be displayed on the cut selection screen (FIG. 7) on the basis of the cut allocation data D1 (S1). For example, the cut list generation processing (S1) is repeatedly executed in the present system 10 in accordance with the progress status of video shooting and various operations of the user during execution of the cut shooting function, and sequentially updates the cut list 30. Details of the processing of step S1 will be described later.

Next, the controller 210 causes the display 240 to display a cut selection screen on the basis of the generated cut list 30 and the cut allocation data D1 as illustrated in FIG. 7, for example (S2).

As illustrated in FIG. 7 the cut list 30 on the cut selection screen includes a plurality of cut icons 3. Each cut icon 3 indicates an individual cut as an option, for example. The selected cut icon 3 is set to the cut number “1” in the initial state, for example.

For example, the controller 210 controls the display 240 to highlight the cut icon 3 indicating the selected cut (S2). For example, the highlighting of the selected cut icon 3 is a larger display size than that of the other cut icons 3, a frame enclosure of a highlight color, and the like. Referring to the cut allocation data D1, the controller 210 causes the storyboard display field 31 to display the storyboard information about the cut indicated by the selected cut icon 3 (S2).

In the example of FIG. 7, the cut of the cut numbers “1” and “3” is in a state where imaging is not completed, and the cut of the cut numbers “2” and “4” is in a state where imaging is completed. In the cut list 30 according to the present embodiment, the cut icon 3 has a display attribute for identifying a state of imaging completion and a state of imaging incomplete. For example, such a display attribute is set so as to highlight the display mode in which the display mode of the shooting completion state is the imaging incomplete state.

The controller 210 receives various user operations with the user interface 230 such as a touch panel while the display 240 displays the cut selection screen as illustrated in FIG. 7, for example (S3). The target user operation in step S3 includes (I) a cut selection operation, (II) a transition operation to the recording mode, (III) a transition operation to the playback mode, (IV) a filtering operation, (V) a cut addition operation, and (VI) an end operation.

The cut selection operation ((I) in S3) is a user operation of changing the selected cut, and is an operation of tapping the cut icon 3 other than the selected cut icon 3 in the cut list 30 displayed on the cut selection screen, for example. The cut selection operation is not limited thereto, and for example, a swipe operation in the storyboard display field 31 may be input as a cut selection operation of changing the selected cut to an adjacent cut.

When the cut selecting operation is input ((I) in S3), the controller 210 changes the selected cut icon 3 according to the input cut selecting operation (S4), and performs the processing in and after step S2 again. As a result, on the cut selection screen, the selected cut icon 3 is changed, and the storyboard display field 31 is displayed for a new selected cut (S2).

The transition operation to the recording mode ((II) in S3) is a user operation for shifting to the recording mode, which is an operation mode for shooting a video related to the selected cut, and is a tap operation on the recording mode button 34, for example. Additionally or alternatively, the transition operation may be a swipe operation in a predetermined one of the ±X directions of the cut selection screen. The recording mode button 34 may be omitted.

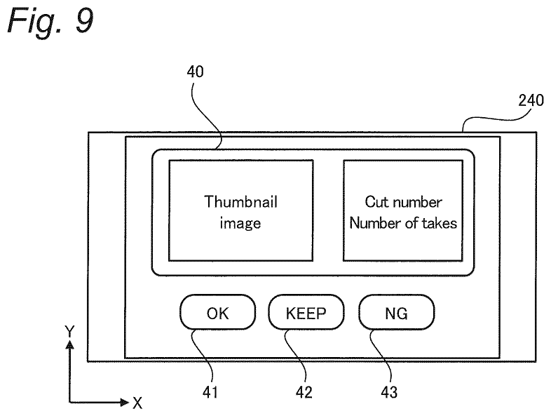

When the transition operation to the recording mode is input ((II) in S3), the controller 210 executes, as the recording mode, various processing for shooting a video of one take in association with the selected cut (S5). A display example in step S5 is illustrated in FIG. 9.

FIG. 9 illustrates a display example of a rating screen in the information support terminal 200. The rating screen is a screen for prompting the user to perform a rating for determining the rating of the video of the imaged take. The rating screen is an example of a rating screen in the information support terminal 200 according to the present embodiment.

As illustrated in FIG. 9 the rating screen includes an information display field 40 for a shot video, an OK button 41, a KEEP button 42, and an NG button 43 as rating options, for example. The information display field 40 displays information related to the video of the shot take, and includes a thumbnail image of the video of the take, a cut number associated with the take, and the number of takes, for example.

The OK button 41 indicates a rating “OK” indicating that the user has determined to want to adopt the take for the corresponding cut, for example. The KEEP button 42 indicates a rating “KEEP” on which it is difficult for the user to determine whether or not to adopt the take, for example. The NG button 43 indicates a rating “NG (No Good)” in which the user has determined that it is clear that the take is not adopted, for example. In the present embodiment, the rating “NG” is an example of a first rating, and the ratings “OK” and “KEEP” are examples of a second rating.

In the recording mode processing (S5) according to the present embodiment, every time video shooting of one take is performed the rating screen of FIG. 9 is displayed to acquire rating information indicating a rating of the user of the take, for example. On the basis of the rating result of the recording mode processing (S5), the controller 210 performs the cut list generation processing (S1) again as illustrated in FIG. 8 to update the cut list 30. Details of the processing of step S5 will be described later.

The transition operation to the playback mode ((III) in S3) is a user operation for shifting to the playback mode, which is an operation mode for reproducing and displaying a video shot with respect to the selected cut, and is an operation of the playback mode button 35, for example. Additionally or alternatively, the transition operation to the playback mode may be a swipe operation in a direction opposite to the transition operation to the recording mode among the ±X directions of the cut selection screen. The playback mode button 35 may be omitted.

When the transition operation to the playback mode is input ((III) in S3), the controller 210 executes processing of reproducing videos of various takes related to the selected cut as the playback mode (S6). In a playback mode processing (S6) in the present embodiment, re-rating for changing the rating on the video of each take can be executed. On the basis of the re-rating result of the playback mode processing (S6), the controller 210 performs the cut list generation processing (S1) again to update the cut list 30. Details of the processing of step S6 will be described later.

The filtering operation ((IV) in S3) is a user operation for narrowing down the cuts to be displayed in the cut list 30, and is an operation of the filter button 32, for example. When a filtering operation is input ((IV) in S3), the controller 210 acquires a condition for filtering cuts to be displayed in accordance with user's selection (S7).

The information support terminal 200 according to the present embodiment uses, as a filtering condition for the cut list 30, an shooting location in the illustrated storyboard information of each cut. The controller 210 performs the cut list generation processing (S1) again on the basis of the shooting location acquired as the filtering condition. In this way, the cut list 30 is updated so as to be limited to the cut icon 3 corresponding to the shooting location of the filtering condition (details will be described later).

The cut adding operation ((V) in S3) is a user operation of adding a new cut in addition to the existing cut in the cut list 30, and is an operation of the cut addition button 33, for example. When the cut adding operation is input ((V) in S3), the controller 210 sets various information on the additional cut (S8) and performs the cut list generation processing (S1) again (details will be described later).

The end operation ((VI) in S3) is a user operation for ending the cut shooting function, and is an operation of the return button 15 on the cut selection screen (FIG. 7), for example. For example, when an end operation is input ((VI) in S3), the controller 210 causes the display 240 to transition from the cut selection screen to the function selection screen (FIG. 4) and ends the processing illustrated in this flow.

According to the above processing, the user of the present system 10 can perform video shooting of a desired cut (S5) or perform playback display (S6) with checking various cuts on the cut selection screen (FIG. 7) in the cut shooting function of the information support terminal 200 (S4). In this way, the user can easily manage the video shooting of the plurality of cuts in the scenario.

On the cut selection screen according to the present embodiment, each of the cut icons 3 is identified and displayed depending on whether or not the imaging is completed, and thus, it is possible to suppress a situation that a cut is forgotten by a user to shoot. As the identification display of whether or not imaging of each cut is completed is performed so as to reflect the rating of the video of each take by the user, it can be facilitated to ensure the video quality according to the intention of the user. Such rating is performed every time a take is shot (S5), and re-rating can be performed in the playback mode (S6). As a result, it is possible to easily realize quality management of video shooting according to the intention of the user.

The cut selection screen (FIG. 7) according to the present embodiment is not limited to the update of the cut list 30 according to the rating/re-rating of cuts as described above (S5, S6, S1), and can also be updated by filtering or adding cuts to the display target (S7, S8, S1). As a result, the user can efficiently use a desired cut on the cut selection screen at the site of video shooting, and can easily use the cut shooting function of the present system 10, for example.

In the cut shooting function according to the present embodiment, communication connection with the digital camera 100 may be managed, and for example, a button for managing communication connection may be provided on the cut selection screen. When the communication connection with the digital camera 100 is not established, the controller 210 may disable the operation to transit to the recording mode ((II) in S3).

### 2.2.2. Cut List Generation Processing

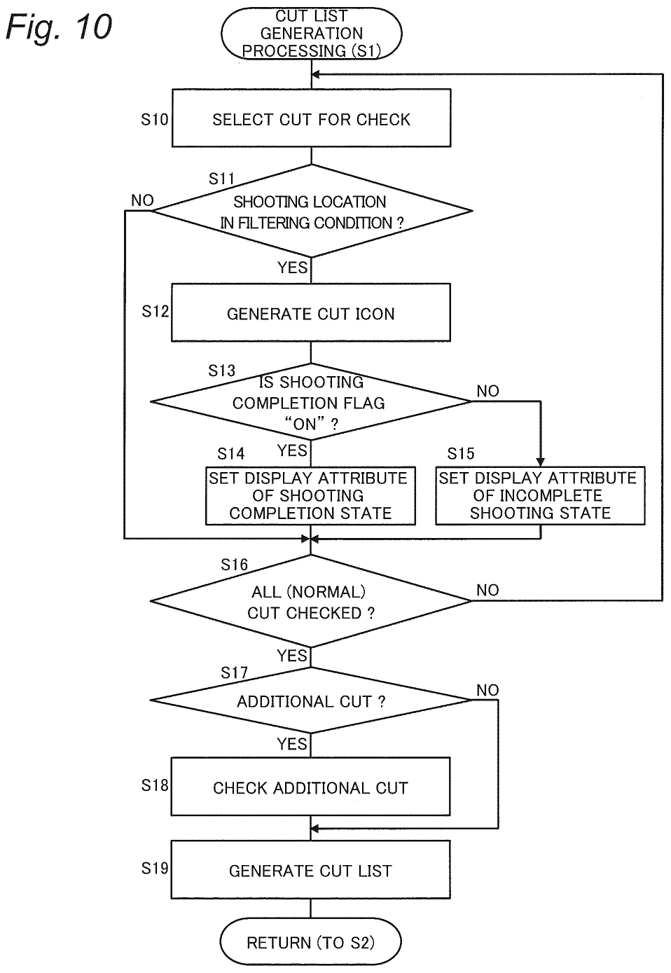

Details of the cut list generation processing in step S1 of FIG. 8 will be described with reference to FIGS. 10 to 12.

FIG. 10 is a flowchart illustrating the cut list generation processing (S1) in the present system 10. The processing illustrated in the flow of FIG. 10 is started in response to the operation of the shooting button 12 on the function selection screen (FIG. 4), for example. Alternatively, the processing of this flow is started after the execution of steps S5 to S8 in response to a predetermined user operation ((II) to (V) in S3 of FIG. 8) on the cut selection screen (FIG. 7).

First, the controller 210 of the information support terminal 200 selects one cut from among all cuts included in the cut allocation data D1 (FIG. 6) as a check target for such as determination whether to provide the cut in the cut list 30 (S10). The selection in step S10 is performed in ascending order for the cut numbers in the cut allocation data D1, for example.

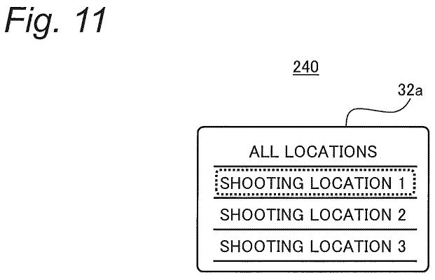

Next, the controller 210 determines whether the shooting location of the cut to be checked corresponds to the filtering condition on the basis of the shooting location of the cut to be checked in the cut allocation data D1, for example (S11). Such filtering will be described with reference to FIG. 11.

FIG. 11 illustrates a display example of a selection dialog 32a in step S7 of FIG. 8. For example, when the user taps the filter button 32 on the cut selection screen of FIG. 7 ((IV) in S3), the display 240 displays the selection dialog 32a in step S7. The selection dialog 32a includes options of filtering conditions such as “all locations”, “shooting location 1”, and “shooting location 2”.

For example, the filtering condition is set to “all locations” as an initial state (see the filter button 32 of FIG. 7), and in this case, the determination in step S11 is “YES”. When the user's filtering operation ((IV) in S3 of FIG. 8) selects a specific shooting location as the filtering condition in (S7), the controller 210 determines whether the shooting location of the cut to be checked matches the specific shooting location (S11).

In step S7 of FIG. 8, the controller 210 displays the selection dialog 32a (FIG. 11) on the basis of various shooting locations included in the cut allocation data D1, and receives a user operation of selecting any option on the selection dialog 32a. For example, when the user taps any option on the selection dialog 32a, the controller 210 acquires an shooting location of the option as a filtering condition (S7), and performs the determination of step S11 of the cut list generation processing (S1) on the basis of the filtering condition.

Referring back to FIG. 10, when the shooting location to be checked does not correspond to the filtering condition (NO in S11), the controller 210 proceeds to step S16 without performing steps S12 to S15 such as generation of cut icon 3. In this way, a cut different from the shooting location of the filtering condition is excluded from the display target in the cut list 30.

When the shooting location to be checked corresponds to the filtering condition (YES in S11), the cut is provided as the display target of the cut list 30. In this case, the controller 210 generates the cut icon 3 corresponding to the cut, for example (S12).

Next, the controller 210 determines whether or not the shooting completion flag of the cut that has generated the cut icon 3 is ON on the basis of the cut allocation data D1, for example (S13). For example, the shooting completion flag is turned on when the video associated with the cut to be checked includes a video rated as “OK” or “KEEP”, and is turned off otherwise. The determination in step S13 may be made by referring to the rating of each video associated with the cut to be checked instead of using the shooting completion flag.

When the shooting completion flag of the cut is ON (YES in S13), the controller 210 sets the display attribute of the shooting completion state in the corresponding cut icon 3 (S14).

On the other hand, when the shooting completion flag of the cut is not ON but OFF (NO in S13), the controller 210 sets the display attribute of the image shooting incomplete state to the corresponding cut icon 3 (S15).

The controller 210 determines whether all the cuts to which the cut numbers are assigned are checked on the basis of the cut allocation data D1, for example (S16). For example, the determination in step S16 is performed within a range of cut included in the cut allocation data D1 (hereinafter referred to as “normal cut”) from the time of planning the scenario separately from the additional cut.

When all the normal cuts have not been checked (NO in S16), the controller 210 performs the processing in and after step S11 again for the unchecked normal cut. Thus, the display target of the cut list 30 is sequentially checked for all the normal cuts (YES in S16).

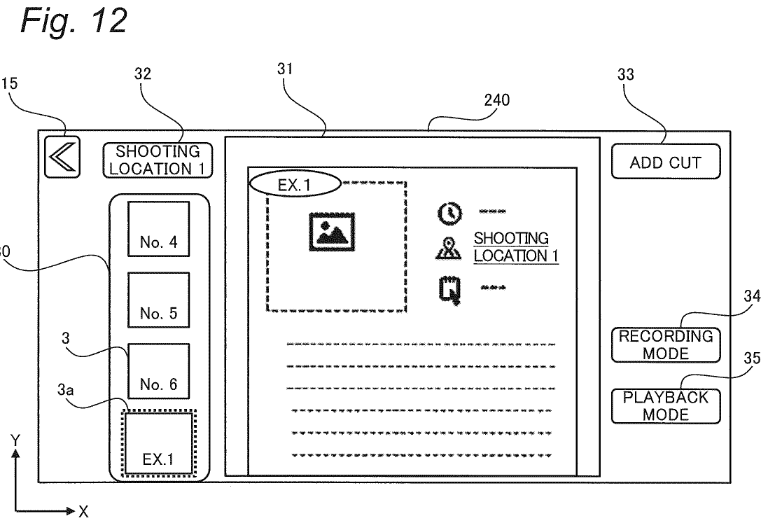

When all the normal cuts are checked (YES in S16), the controller 210 determines whether or not an additional cut is present, for example (S17). In step S8 of FIG. 8, the additional cut is set so as to be assigned an additional cut number which is identification information different from the cut number in the cut allocation data D1, for example (see FIG. 12).

When no additional cut is present (NO in S17), the controller 210 generates the cut list 30 on the basis of the check result of the normal cut (S11 to S16) without particularly performing the processing of step S18 (S19). For example, the cut icons 3 to be displayed in the cut list 30 are arranged in ascending order of cut numbers.

On the other hand, when an additional cut is present (YES in S17), the controller 210 performs various processes of checking the display target of the cut list 30 for the additional cut similarly to the normal cut (S18). The processing of step S18 is performed similarly to the processing of steps S11 to S16 with the range of the additional cut as a check target instead of the normal cut. In this case, based on the check results of the normal cut and the additional cut (S11 to S16, S18), the controller 210 generates the cut list 30 (S19).

When the cut list 30 is generated in this manner (S19), the controller 210 ends the processing of step S1 of FIG. 8 and proceeds to step S2, for example.

According to the cut list generation processing (S1) described above, the information support terminal 200 of the present system 10 generates the cut list 30 listing cuts included in the scenario on the basis of the cut allocation data D1 so as to identify and display whether or not the imaging is in a completion state (S14, S15). Such identification display of the cut list 30 is dynamically updated according to the changed rating when the rating for each take in each cut changes (S5, S6 of FIG. 8). This makes it easy for the user to check the progress status of the video shooting of the plurality of cuts.

In the present system 10, the cut list 30 can be narrowed down using the shooting location as the filtering condition (see S7 of FIGS. 8 and S11 of FIG. 10). As a result, the user can use the cut selection screen by selecting the shooting location at the site as the filtering condition to narrow down the cut to be shot at the site, for example. In this way, the present system 10 can facilitate to suppress for the user to forget to shoot a video for a cut at the site.

In the present system 10, the cut list 30 can also be updated to include additional cuts (see S8 of FIGS. 8 and S17 to S18 of FIG. 10). The cut list 30 in a case with an additional cut is illustrated in FIG. 12.

For example, when the user performs a cut adding operation ((V) in S3 of FIG. 8), the controller 210 sets an additional cut (S8), proceeds to YES in step S17 in the subsequent cut list generation processing (S1), and checks the additional cut (S18). Thus, as illustrated in FIG. 12, the cut list 30 is updated to include the cut icon 3a for the additional cut, for example.

With such an additional cut of the present system 10, the user can immediately add the cut at the site, for example at the shooting location, without particularly re-editing the scenario. For example, in step S1 after step S8, the cut icon 3a for the additional cut is arranged at the end of the cut list 30 as illustrated in FIG. 12. In a case with a plurality of additional cuts, the additional cuts are arranged in ascending order of the additional cut numbers, for example.

In step S8 of FIG. 8, the controller 210 automatically sets the shooting location in the illustrated storyboard information of the additional cut according to the filtering condition, for example. Alternatively, the shooting location of the additional cut may be set by a user input. By setting the shooting location of the additional cut, the additional cut can also be subjected to the filtering (S7) similarly to the normal cut. For example, the storyboard information of the additional cut is set to an empty value except for the shooting location. As the composition of the storyboard information, a predetermined image indicating additional cut may be used. The additional cut may be deleted by a predetermined user operation, and for example, the predetermined user operation may be a long press operation of the cut icon 3a for the additional cut.

### 2.2.3. Recording Mode

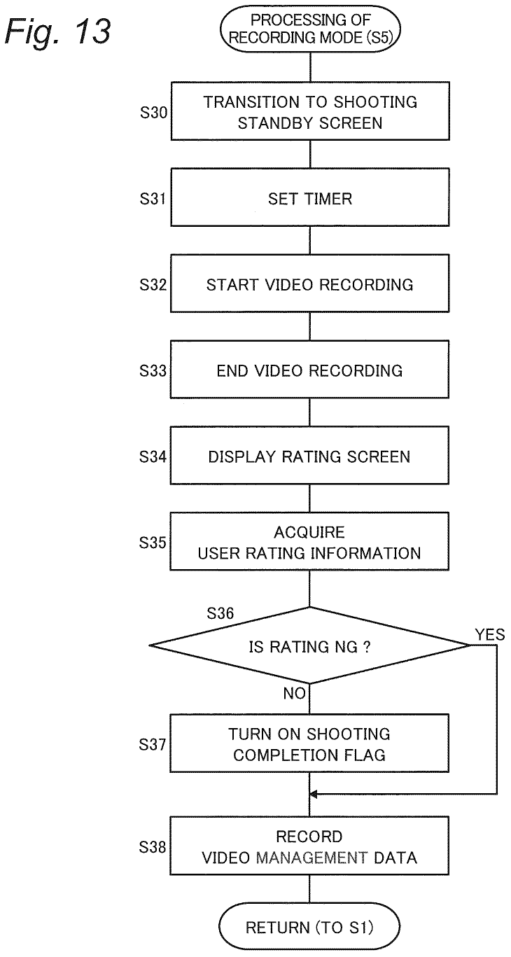

Details of the recording mode processing in step S5 of FIG. 8 will be described with reference to FIGS. 13 to 15.

FIG. 13 is a flowchart illustrating recording mode processing (S5) in the present system 10. The processing illustrated in the flow of FIG. 13 is started when a transition operation to the recording mode is input on the cut selection screen of FIG. 7, for example ((II) in S3).

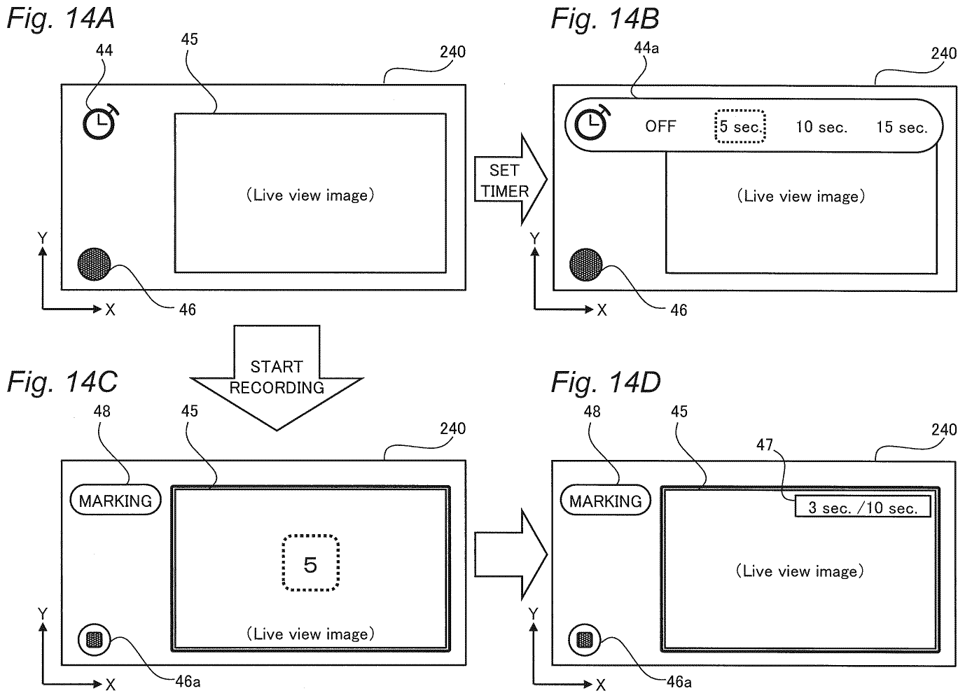

First, the controller 210 of the information support terminal 200 shifts to the recording mode and causes the display 240 to transition to a screen for waiting for video shooting (S30). FIG. 14A illustrates a display example of the information support terminal 200 in step S30.

As illustrated in FIG. 14A, the recording standby screen in step S30 includes a timer button 44, a live view image 45, and a recording button 46, for example. The timer button 44 receives a user operation for setting a timer period for performing timing at the start of imaging, for example. The recording button 46 receives a user operation for starting shooting and recording of a video.

In the present system 10, when shifting to the recording mode, the controller 210 of the information support terminal 200 requests the digital camera 100 to transmit the live view image 45 via the communication interface 250, for example (S30). For example, in the recording mode, the controller 210 sequentially receives the image data of the live view image 45 from the digital camera 100 via the communication interface 250, and displays the live view image 45. For example, the controller 210 receives audio data of a sound collection result of the microphone 160 from the digital camera 100 in a timely manner. The controller 210 sets a timer period in accordance with a user operation of the timer button 44, for example (S31). FIG. 14B illustrates a display example of the information support terminal 200 in step S31. The setting of the timer period may be performed for each take or may be uniform for each cut.

FIG. 14B illustrates a timer selection field 44a displayed in response to the operation of the timer button 44 on the imaging standby screen of FIG. 14A. FIG. 14B illustrates an example in which the timer period is set to “5 seconds” in the timer selection field 44a. For example, the timer selection field 44a includes options indicating numerical values of the timer period “OFF” and “5 seconds” corresponding to the timer period of 0 seconds. In step S31, when receiving the user operation in the timer selection field 44a in the user interface 230, the controller 210 sets the timer period according to the user operation, and returns the display 240 from FIG. 14B to FIG. 14A.

In response to the user operation on the recording button 46, the controller 210 performs various types of control to start shooting and recording of the video of one take associated with the selected cut (S32). For example, in step S32, the controller 210 instructs the digital camera 100 to start shooting and recording of a video via the communication interface 250. A display example of the information support terminal 200 in step S32 is illustrated in FIGS. 14C and 14D.

FIG. 14C illustrates a vide shooting screen when the recording button 46 is operated when the timer period is set as in the example of FIG. 14B. FIG. 14D illustrates a vide shooting screen after the timer period from FIG. 14C. At the time of operation of the recording button 46 (S32), the controller 210 performs a countdown of the lapse of time by the set timer period, and superimposes and displays the time on the live view image, for example. In the present example, the video recording is performed in a period including such a timer period. On the other hand, when the timer period is set to “OFF”, the controller 210 does not particularly perform the countdown display as illustrated in FIG. 14C in step S32, and causes the display 240 to transition to a vide shooting screen as illustrated in FIG. 14A to FIG. 14D, for example.

As illustrated in FIGS. 14C and 14D, the vide shooting screen in step S32 includes the live view image 45, a time display field 47, a recording stop button 46a, and a marking button 48, for example. For example, highlighting such as frame display indicating that recording is being performed is performed on the live view image 45 on the vide shooting screen. For example, the time display field 47 compares and displays the shooting time of the selected cut in the cut allocation data D1 with the elapsed time from the start of imaging of the video of the take.

In step S32, the controller 210 controls the display 240 to switch the display from the imaging standby screen (FIG. 14A) to the vide shooting screen (FIGS. 14C and 14D). The controller 135 of the digital camera 100 starts shooting of a video in accordance with an instruction from the information support terminal 200 received via the communication module 155, for example.

At this time, the controller 135 repeats the imaging operation of the image sensor 115 and records the video data of the shooting result in the memory card 142 via the card slot 140, for example. The video data includes audio data of a sound collection result of the microphone 160, for example. The controller 135 may start sound collection synchronized with video shooting in the digital camera 100 from such an imaging instruction. For example, the controller 135 of the digital camera 100 determines a file name of the video data according to the shooting order, and transmits the determined video file name to the information support terminal 200 via the communication module 155.

For example, on the vide shooting screen of FIG. 14D, the recording stop button 46a receives a user operation for stopping shooting and recording of a video. The marking button 48 receives a user operation of performing marking at a timing desired by the user during shooting of the video. For example, the user can use the marking button 48 at a timing desired to be referred to at the time of video editing of post-processing.

Thereafter, the controller 210 performs various types of control so as to stop the shooting and recording of the video in response to the user operation of the recording stop button 46a (S33). For example, in step S33, the controller 210 instructs the digital camera 100 to stop shooting and recording of a video via the communication interface 250. The controller 210 stops video recording of the live view image 45 in the information support terminal 200 (S33). The controller 135 of the digital camera 100 ends shooting a video in accordance with an instruction from the information support terminal 200.

For example, in order to prompt the user to rate the video of the take shot as described above, the controller 210 displays a rating screen on the display 240, as illustrated in FIG. 9 (S34).

The controller 210 receives a user operation of the various buttons 41 to 43 on the rating screen as illustrated in FIG. 9, and acquires the rating of the user as a result of the rating of the video of the shot take, for example (S35). In the present embodiment, every time a video of one take is shot, a user can arbitrarily select a desired rating from the above three types of rating “OK”, “KEEP”, and “NG” for a video shot without interfering with rating of a video of another take in particular.

The controller 210 determines whether or not the rating is “NG” on the basis of the acquired rating of the user, for example (S36). For example, when the rating of the user is “OK” or “KEEP”, the determination in step S36 is “NO”.

When the acquired rating of the user is not “NG” (NO in S36), the controller 210 sets the shooting completion flag of the cut associated with the take (i.e., the selected cut) in the cut allocation data D1 to “ON” (S37). For example, in the case where the number of takes of the video is “1”, or the case where a rating of a video of an existing take is “NG” in the number of takes equal to or greater than “2”, the shooting completion flag is switched from “OFF” to “ON” by the execution of step S37.

On the other hand, when the acquired rating of the user is “NG” (YES in S36), the controller 210 proceeds to step S38 without particularly updating the setting of the shooting completion flag. Thus, when the shooting completion flag of the corresponding cut is in the OFF state when the video having the rating “NG” is shot, the OFF state is kept, for example. For example, when a video of a take shot in the past has “KEEP” or “OK”, and thus the shooting completion flag is in an ON state, the ON state is kept.

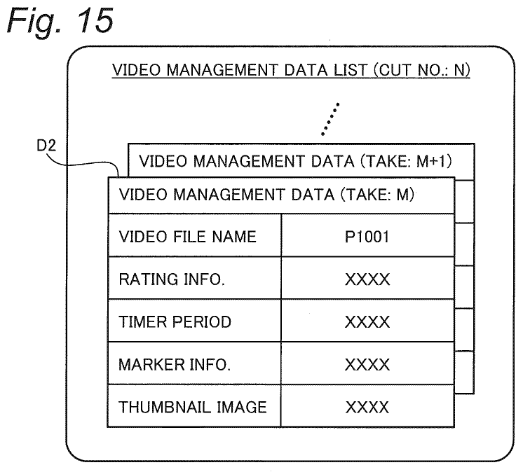

The controller 210 generates management data of a video of a take shot as described above, and records the management data in the cut allocation data D1 in the memory 220, for example (S38). Such video management data D2 is illustrated in FIG. 15.

For example, as illustrated in FIG. 15, the video management data D2 includes “video file name”, “rating information”, “timer period”, “marker information”, and “thumbnail image”. For example, the controller 210 provides the video file name received from the digital camera 100 for the video shot in steps S32 to S33, the rating of the user acquired in step S35, and the timer period set in step S31 in the video management data D2. When the user operation of the marking button 48 is performed, the controller 210 specifies the timing of the user operation during the video shooting time and provides the timing in the video management data D2 as marker information.

For example, the controller 210 generates a thumbnail image of the video under shooting, based on the live view image 45 received from the digital camera 100 via the communication interface 250 in steps S32 to S33, to include the thumbnail image in the video management data D2 (S38). For example, when the timer period is “OFF”, the thumbnail image is based on a frame image at a timing upon operating the record button 46. When the timer period is set to a period other than “OFF”, the thumbnail image is based on a frame image at a timing after operating the record button 46 by the set timer period.

The controller 210 stores the generated video management data D2 in the video management data list of cuts associated with the video in the cut allocation data D1 (FIG. 6) (S38). For example, as illustrated in FIG. 15, the video management data D2 with the cut number N is stored and managed in order of the number of takes in the video management data list with the cut number N. Such a storage order is realized as a result of arrangement in ascending order for video files, for example.

For example, the controller 210 ends the recording mode processing (S5) by storing the video metadata D2 (S38), and proceeds to step S1 of FIG. 8.

According to the recording mode processing (S5) described above, the present system 10 can shoot and record a video of one take of the selected cut and prompt the user to rate the cut (S32 to S35). The present system 10 manages an image shooting completion flag of the cut on the basis of the acquired rating information (S36, S37). In this way, the rating information of the user for each take can be appropriately reflected in the management of whether or not the cut is in the shooting completion state. In addition, according to the recording mode processing (S5) according to the present embodiment, the information support terminal 200 can control the shooting and recording of the video by the digital camera 100 to realize the management of the video shooting.

In steps S32 to S33, the controller 210 of the information support terminal 200 may record a video file indicating the live view image 45 sequentially received from the digital camera 100 after the operation of the record button 46 in the memory 220 of the information support terminal 200. The video file may include audio data collected by the microphone 160 in synchronization with video shooting by the digital camera 100. For example, the controller 210 may determine the file name of the video file, based on the cut allocation data D1 or the like, and may include the determined file name in the instruction to the digital camera 100.

In the rating (S34 and S35) of the video of each take, a plurality of takes of the same rating may be present among a plurality of takes associated with the same cut. For example, a video of a plurality of takes for the same cut may have a rating “OK”.

In addition, the rating screen displayed in step S34 may be displayed as a dialog. For example, the controller 210 may control the display 240 to superimpose and display the dialog of the rating screen on the display screen before and after step S33.

For example, the recording standby screen in the recording mode (FIG. 14A) may further include a return button 15 for an operation of returning the screen transition to the cut selection screen. The return operation may be a swipe operation in a predetermined one of the ±X directions of the video management screen. The information support terminal 200 may shift to the playback mode by a swipe operation in the opposite direction.

### 2.2.4. Playback Mode and Reviewing Function for Cut Error

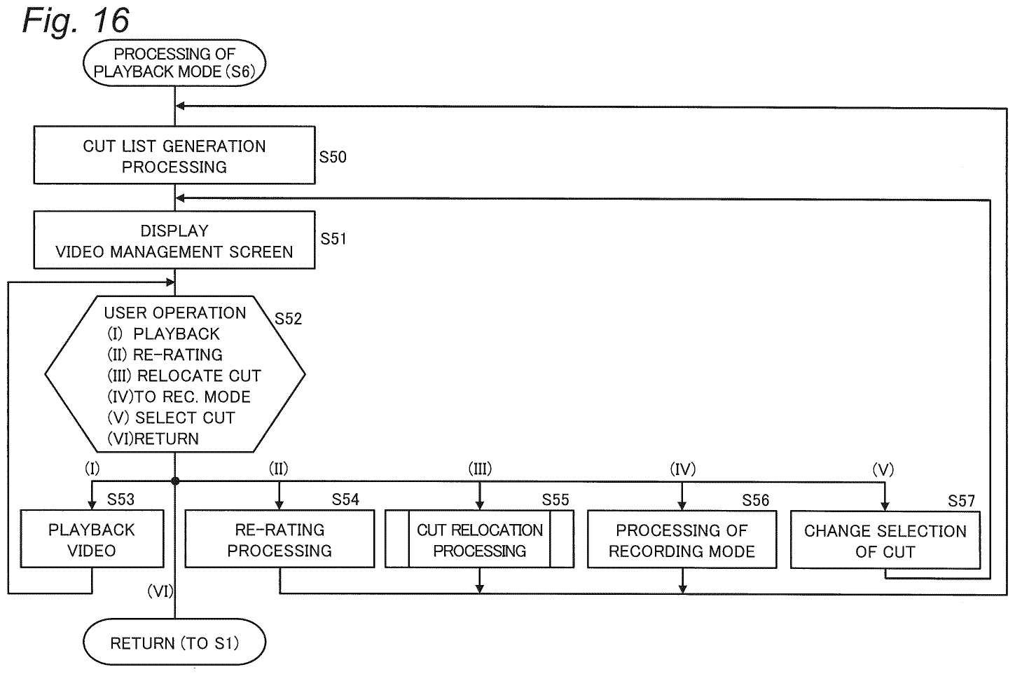

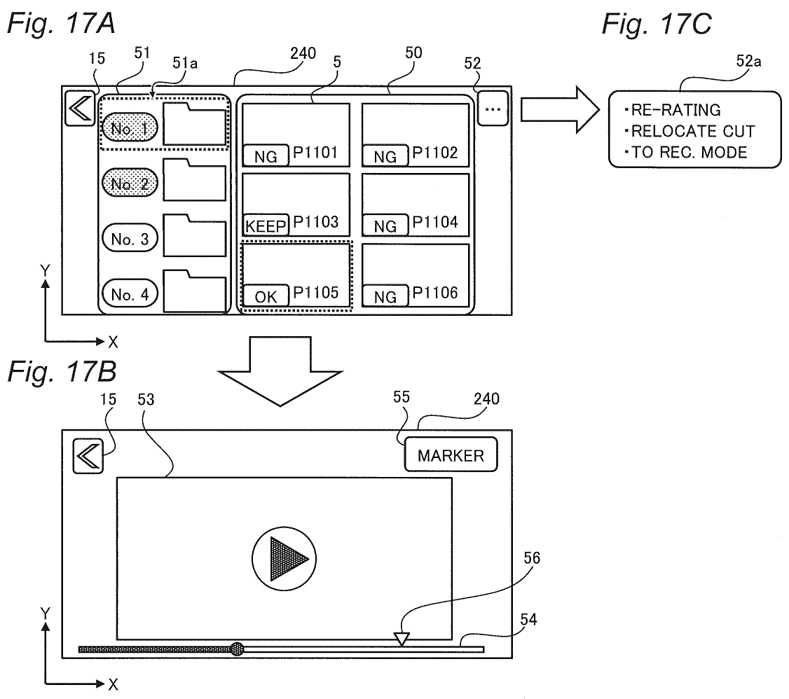

The playback mode processing in step S6 in FIG. 8 will be described with reference to FIGS. 16 to 17. In the recording mode described above, the video is shot to record in association with a cut selected by the user. When the user makes a mistake in selecting a cut at the time of such video shooting, the shot video would be associated with a cut that does not meet the user's intention, and a problem might occur in a workflow of subsequent video production. Therefore, the present system 10 provides a function of reviewing management of a video for each cut in the playback mode, for example.

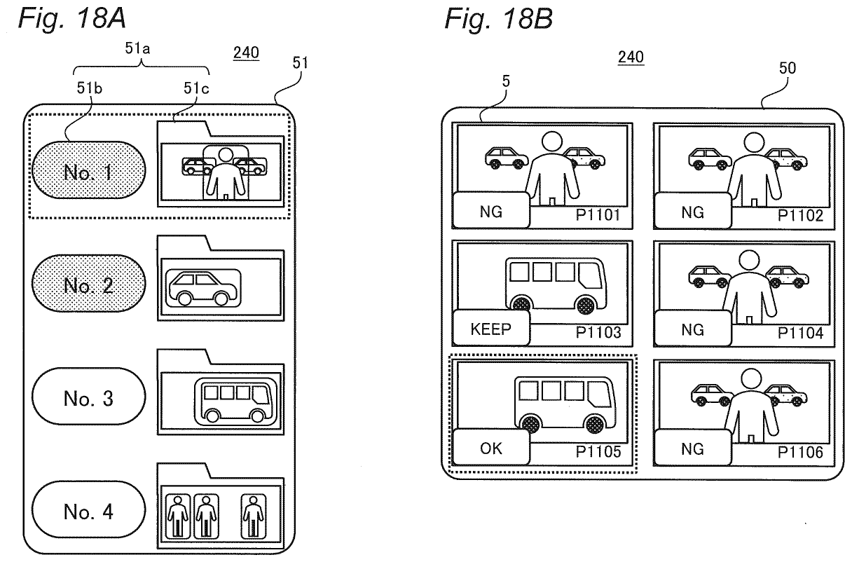

FIG. 16 is a flowchart illustrating the playback mode processing (S6) in the present system 10. FIGS. 17A to 17C are diagrams illustrating a display example in the playback mode of the information support terminal 200. FIGS. 18A and 18B are diagrams for explaining details of the display example in the playback mode.

The processing illustrated in the flow of FIG. 16 is started when a transition operation to the playback mode is input on the cut selection screen (FIG. 7), for example ((III) in S3). FIG. 17A illustrates a display example of a video management screen in the playback mode. FIG. 17B illustrates a display example of a video playback screen in the playback mode. FIG. 17C illustrates a display example of a selection menu 52a in the playback mode.

First, the controller 210 of the information support terminal 200 performs cut list generation processing (S50) for the playback mode, based on the selected cut and the cut allocation data D1, and causes the display 240 to transition to a screen for managing a video for each cut, for example (S51). FIG. 17A illustrates a display example of the information support terminal 200 in step S51.

FIG. 17A illustrates an example of the video management screen with the cut whose cut number is “1” being selected. The video management screen includes a cut list 51 for a playback mode, a video list 50, a menu button 52, and the return button 15, for example. For example, the cut list 51 for the playback mode includes a plurality of cut icons 51a similarly to the cut list 30 on the cut selection screen (FIG. 7), and a selected cut is indicated by highlighting in the cut icons 51a. The video list 50 includes a video icon 5 indicating a video for each take in the selected cut.

FIG. 18A illustrates a display example of the cut list 51 for the playback mode on the video management screen of FIG. 17A. The cut icon 51a in the cut list 51 is illustrated. In the cut list 51 for the playback mode, the cut icon 51a includes a cut number field 51b indicating identification information of a corresponding cut, and a cut folder 51c that is a folder-shaped operation icon, for example. For example, the cut icon 51a displays the composition of the storyboard for the corresponding cut, based on the composition information of the cut allocation data D1 in the cut folder 51c (see FIG. 5B). The cut icon 51a displays whether or not the cut is in a shooting completion state, identified by a color in the cut number field 51b, for example.

In step S50, the controller 210 performs, processing similar to the above-described cut list generation processing (S1 in FIG. 8) to generate the cut list 51 for the playback mode, for example. In the cut list generation processing (S50), upon performing processing similar to steps S10 to S19 in FIG. 10, the controller 210 generates the cut icon 51a for the playback mode instead of the cut icon 3 in step S12, for example.

FIG. 18B illustrates a display example of the video list 50 on the video management screen of FIG. 17A. For example, the video icon 5 includes a thumbnail image of a video in the take, rating information, and a video file name. In step S51 for example, referring to the video management data list of the cut in the cut allocation data D1, the controller 210 generates each video icon 5 so as to visualize the rating information of each take associated with the cut. For example, the controller 210 arranges each video icon 5 in ascending order of the video file name to generate the video list 50 (S51).

For example, as illustrated in FIG. 17A, the controller 210 receives various user operations via the user interface 230 in a state where the display 240 displays the video management screen (S52). The target user operation in step S52 includes (I) a playback selection operation, (II) a re-rating operation, (III) a cut relocation operation, (IV) a transition operation to recording mode, (V) a cut selection operation, and (VI) a return operation.

The playback selection operation ((I) in S52) is a user operation of selecting a video file to be played, and is an operation of tapping a desired video icon 5 in the video list 50 displayed on the video management screen, for example.

On the video management screen (FIG. 17A), the menu button 52 receives a touch operation for switching display/non-display of the selection menu 52a (FIG. 17C) in the playback mode, for example. The selection menu 52a includes menu items corresponding to (II) to (IV) in step S52 as choices selectable by the user, for example.

The re-rating operation ((II) in S52) is a user operation for re-rating a video file. For example, this operation is a touch operation of selecting the corresponding option “re-rating” in the selection menu 52a from the menu button 52 and then tapping the desired video icon 5.

The cut relocation operation ((III) in S52) is a user operation for starting a change in cut to be associated with a video in the present system 10. For example, this operation is a touch operation of selecting the corresponding option “relocate cut” in the selection menu 52a from the menu button 52. For example, when the user of the present system 10 finds the video icon 5 with the wrong cut association from the video list 50 on the video management screen, the user can input the cut relocation operation ((III) in S52).

When the cut relocation operation is input ((III) in S52), the controller 210 executes cut relocation processing that is processing of changing association between a cut and a video according to a user operation (S55). In the cut relocation processing (S55) of the present embodiment, a user operation of moving the video icon 5 between the cut folders 51c is received, and for example, the management of the association between the cut and the video is updated in the cut allocation data D1. Details of the processing in step S55 will be described later.

After the cut relocation processing (S55), the controller 210 again performs, the processing in and after step S50, for example. Thus, the cut list 51 for the playback mode and the video management screen are updated and displayed by the cut relocation processing (S55), for example (S50 to S51).

In step S52, the controller 210 receives an operation to transit to the recording mode, similarly to (II) in step S3 in FIG. 8, for example ((IV) in S52). The transition operation from the video management screen (FIG. 17A) to the recording mode ((IV) in S52) is a touch operation of selecting a corresponding option in the selection menu 52a from the menu button 52, for example. Alternatively, the present operation may be a swipe operation in a predetermined one of the ±X directions of the video management screen. The option corresponding to (IV) in step S52 in the selection menu 52a may be omitted.

When the transition operation to the recording mode is input ((IV) in S52), the controller 210 performs the processing of the recording mode (S56) similarly to step S5 in FIG. 8, for example, and returns to step S50, for example. Thus, the information support terminal 200 updates the cut list 51 and the video management screen in association with the selected cut of the video newly shot in the recording mode (S50 to S51).

In step S52, the controller 210 receives the cut selection operation, similarly to (I) in step S3 in FIG. 8, for example ((V) in S52). The cut selection operation ((V) in S52) on the video management screen (FIG. 17A) is a tap operation on the cut icon 51a in the cut list 51 for the playback mode, for example.

When the cut selection operation is input ((V) in S52), the controller 210 changes the selected cut, for example, similarly to step S4 in FIG. 8 (S57), and returns to step S51, for example. In this way, the information support terminal 200 displays the video management screen including the video list 50 of the newly selected cut (S51).

The return operation in (VI) in step S52 is a user operation for returning to the function selection screen from the playback mode, and is an operation of the return button 15 on the video management screen, for example. For example, this operation ((VI) in S52) may be a swipe operation in a direction opposite to the transition operation to the recording mode ((IV) in S52) of the ±X directions of the video management screen.

When the playback selection operation is input on the video management screen as in FIG. 17A ((I) in S52), the controller 210 causes the display 240 to transition to a screen for reproducing and displaying the selected video file, and perform the processing to play the video (S53). A display example of the information support terminal 200 in step S53 is illustrated in FIG. 17B.

As illustrated in FIG. 17B, the playback screen in step S53 includes a playback image 53, a playback control bar 54, a marker button 55, and the return button 15, for example. The controller 210 causes the user interface 230 to receive various user operations related to the playback screen. For example, the user can switch playback/pause of a video by a tap operation on the playback image 53, and change the playback position by a tap operation on the playback control bar 54.

The playback control bar 54 indicates a playback timing in the time length of the entire video, and the marker 56 is arranged at a position indicating a specific timing. For example, the controller 210 arranges the marker 56 on the playback control bar 54 with reference to the marker information of the video management data D2. On the playback screen of FIG. 17B, the user can newly arrange the marker 56 by operating the marker button 55 or change the arrangement position by drag operation of the marker 56. When receiving such various marker operations, the controller 210 updates the marker information in the video management data D2 according to the marker operation.

For example, when a user instruction to end playback of the video is input by operation of the return button 15, the controller 210 causes the display 240 to transition from the playback screen (FIG. 17B) to the video management screen (FIG. 17A) for example, and returns to step S52.

When the re-rating operation ((II) in S52) is input on the video management screen (FIG. 17A), the controller 210 performs processing for re-rating (S54). For example, the controller 210 first causes the display 240 to display an operation screen similar to the rating screen (FIG. 9), and receives user operations of various buttons 41 to 43 as options of an evaluation of a user. In this way, the controller 210 acquires the rating information indicating the re-rating result for the take of the video icon 5 selected by the user in (II) in step S52 (S54).

In step S54, the controller 210 updates the cut allocation data D1 on the basis of the acquired rating information of the re-rating result, for example. For example, the controller 210 rewrites the rating information of the take in the video management data list of the selected cut, and manages the shooting completion flag of the selected cut in consideration of the re-rating result. For example, when, from a state in which all the pieces of rating information of the takes associated with the selected cut are in a state of “NG”, any of the pieces of rating information is changed to a state of “KEEP” or “OK” by re-rating, the shooting completion flag is switched from OFF to ON.

Thereafter, the controller 210 returns to step S50 and updates the cut list 51 and the video list 50 on the video management screen so as to reflect the re-rating result (S50 to S51).

For example, when the return operation ((VI) in S52) is input on the video management screen (FIG. 17A), the controller 210 ends the playback mode processing (S6) and returns to step S1 of FIG. 8. The cut list 30 of the cut selection screen (FIG. 7) is also updated in the subsequent cut list generation processing (S1), appropriately.

According to the playback mode processing (S6) described above, the user can check the videos of various takes related to the selected cut in the playback display (S53), and perform the rating again according to the check result (S54). Furthermore, the present system 10 can make it possible to review and easily correct cut error associating the video with a cut that is not intended by the user, by responding to the cut relocation operation of the user ((III) in S52) on the video management screen (FIG. 17A) to perform the cut relocation processing (S55), for example.

In the information support terminal 200 of the present embodiment, the video management screen (FIG. 17A) includes a cut list 51 that shows the storyboards of the respective cuts with cut icons 51a, and a video list 50 that shows thumbnail images of the respective videos with video icons 5, as illustrated in FIGS. 18A and 18B, for example. It is anticipated that the thumbnail image of the video is similar to the storyboard of the cut intended by the user and is different from the storyboard of the unintended cut. Therefore, the present system 10 makes it easy for the user to find a video with a cut error or to consider a cut of a relocation destination to correct the video by comparing the cut icon 51a of the cut list 51 with the video icon 5 of the video list 50 on the video management screen.

For example, in the playback mode of the present system 10, a cut selection operation and a transition operation to the recording mode can be input on the video management screen ((V), (IV) in S52). As a result, the user of the present system 10 can change the selected cut on the video management screen and check videos of various takes over various cuts. For example, when a cut desired to be additionally shot is found as a result of checking the video in the playback mode, the user can immediately transition to the recording mode. In this way, the efficiency of the work of video shooting by the user of the present system 10 can be improved.

On the other hand, when the video management screen transitions to the recording mode, video shooting is performed in association with the selected cut immediately before the shift. Therefore, there may be a cut error that associates the video with a cut that is not intended by the user due to the unexpected transition. At this time, according to the information support terminal 200 of the present embodiment, the user can relocate the video with a cut error to the cut folder 51c desired by the user by the cut relocation processing (S55), and the cut error can be easily corrected.

The playback mode of the present system 10 is not particularly limited to the above example, and for example, the controller 210 may not receive the user operations of (III) and (IV) in step S52. In this case, the processing of steps S56 and S57 can be omitted. In the present system 10, the cut relocation processing (S55) is not particularly limited to the user operation ((III) in S52) from the video management screen in the playback mode, and may be performed according to a user operation from various management screens that are not in the playback mode, for example.

### 2.2.5. Cut Relocation Processing

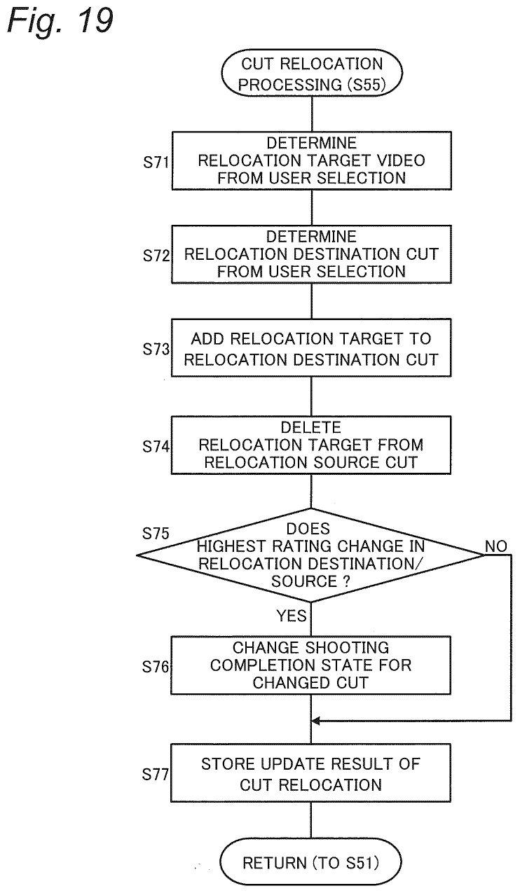

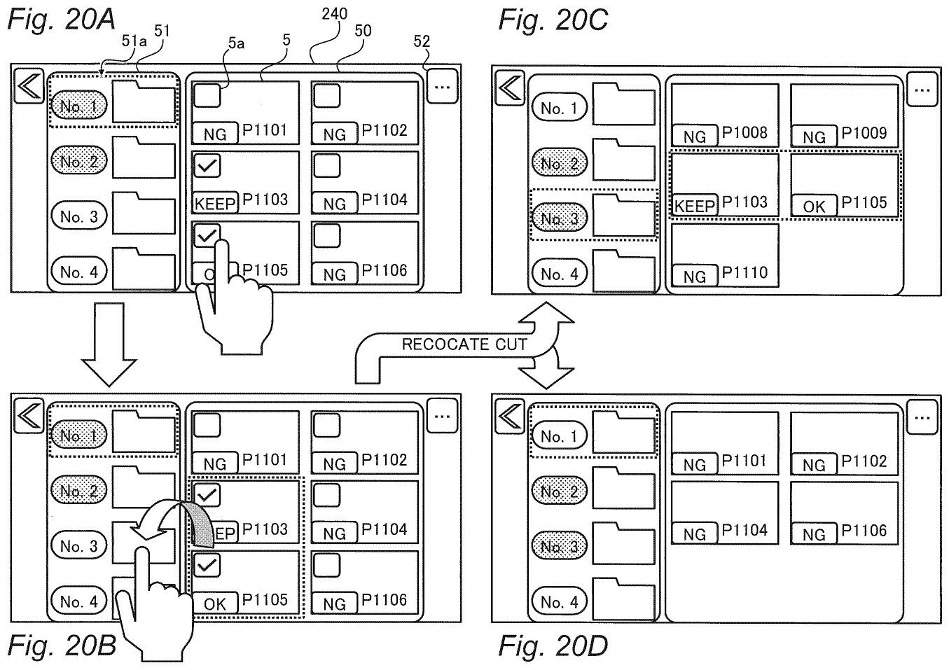

Details of the cut relocation processing in step S55 in FIG. 16 will be described with reference to FIGS. 19 to 20.

FIG. 19 is a flowchart illustrating cut relocation processing (S55) in the information support terminal 200. FIGS. 20A to 20D illustrate display examples in the cut relocation processing (S55).

First, the controller 210 of the information support terminal 200 determines a video selected as a relocation target according to a user operation on the user interface 230 (S71). FIG. 20A illustrates a display example of the information support terminal 200 in step S71.

FIG. 20A illustrates a selection operation of a relocation target that can be input after the cut relocation operation ((III) in S52 in FIG. 16) from the video management screen in FIG. 17A. According to the operation of (III) in step S52 in FIG. 16, the controller 210 causes each video icon 5 in the video list 50 being displayed to display a check box 5a indicating whether or not it is a relocation target in an on/off manner, as shown in FIG. 20A, for example. For example, the initial state of the check box 5a is set to OFF.

In the example of FIG. 20A, in the video list 50 of the cut with the cut number “1” as the relocation source, the videos with the video file names “P1103” and “P1105” are determined as the relocation targets (S71). The user can select the video to be relocated by a tap operation to turn on the check box 5a of the desired video icon 5. For example, the controller 210 receives a tap operation of turning on the check box 5a on the touch panel of the user interface 230 as a selection operation of the relocation target, and determines the selected video as the relocation target (S71). The cut at the relocation source is an example of a first cut in the present embodiment.

Next, the controller 210 determines a cut to be selected as a relocation destination according to a user operation on the user interface 230 (S72). The user can easily select the cut of the relocation destination from the storyboard display (FIG. 18A) of each cut icon 51a in the cut list 51, for example. An operation example of step S72 is illustrated in FIG. 20B. The cut at the relocation destination is an example of a second cut in the present embodiment.

FIG. 20B illustrates, after FIG. 20A, a selection operation of the relocation destination in which the cut with the cut number “3” is input as the relocation destination. For example, the selection operation of the relocation destination is a drag and drop operation from the video icon 5 to be relocated to the cut folder 51c of the cut desired by the user in the video list 50. For example, the controller 210 determines the cut of the drop destination as the relocation destination according to such a selection operation of the relocation destination (S72). As a result, the user can easily select the cut to be associated as the correction result of the cut error, that is, the cut of the relocation destination by an intuitively easy-to-understand operation such as relocation between the cut folders 51c.

Next, based on the information acquired in steps S71 and S72, the controller 210 adds the video management data D2 of the relocation target to the video management data list (FIG. 15) of the cut of the relocation destination, in the cut allocation data D1 (FIG. 6), for example (S73). FIG. 20C illustrates a video management screen regarding the cut at the relocation destination after such correction.

The video management screen of FIG. 20C is displayed in step S51 after the cut relocation processing (S55) of FIG. 16 as a result of the operation example of FIG. 20B. In the video list 50 of the cut at the relocation destination, as illustrated in FIG. 20C, a video icon 5 to be relocated (see FIG. 20A) and an existing video icon 5 for the cut at the relocation destination are arranged in a predetermined order such as ascending order of video file names (or shooting order), for example. The present system 10 may additionally update and manage the number of takes of the cut at the relocation destination in this order.

The controller 210 deletes the video management data D2 of the relocation target acquired in step S71 from the video management data list of the cut of the relocation source in the cut allocation data D1, for example (S74). FIG. 20D illustrates a video management screen of the cut at the relocation source after the update.

The video management screen of FIG. 20D is displayed in step S51 after the cut relocation processing (S55) of FIG. 16 as a result of the operation example of FIG. 20B similarly to FIG. 20C. In the video list 50 of the cut of the relocation source, as exemplified in FIG. 20D, the video icon 5 to be relocated (see FIG. 20A) is deleted, and for example, the remaining video icons 5 are arranged close to each other. The present system 10 may delete and update and manage the number of takes of the cut of the relocation source in such order.

Next, the controller 210 determines whether or not the highest rating changes in the cut of the relocation destination or the relocation source, based on the rating information in the video management data list of each cut of the relocation destination/relocation source before and after the update as described above, for example (S75). The highest rating is the highest rating among the ratings of each video included in the cut. For example, when only a video evaluated as “NG” is present in the cut, the highest rating is “NG”. On the other hand, when the cut includes a video rated as “OK” or “KEEP”, the highest rating is “OK” or “KEEP”.

In step S75, the controller 210 calculates the highest rating of the cuts of the relocation destination before and after step S73, to compare them with each other, for example. The controller 210 calculates the highest rating of the cuts of the relocation source before and after step S74 and compares them with each other. For example, when the highest rating changes in at least one of the cut at the relocation source and the cut at the relocation destination, the controller 210 proceeds to “YES” in step S75. When the highest rating changes between “OK” and “KEEP”, the process may proceed to “NO” in step S75.

When determining that the highest rating changes in the cut at the relocation destination/relocation source (YES in S 75), the controller 210 changes the shooting completion flag according to the updated highest rating in the cut allocation data D1, for example (S76). Such a change in the image shooting completion flag updates the display of the image shooting completion state or the image shooting incomplete state for each cut in the cut list 51 on the video management screen, for example.

For example, in the examples of FIGS. 20A to 20D, the highest rating of the cut (cut number “1”) of the relocation source is changed from “OK” before the update to “NG” after the update as illustrated in FIGS. 20A and 20D (YES in S75). Therefore, the display of the video icon 5 for the cut is changed from the shooting completion state to the shooting incomplete state (S76).

In the examples of FIGS. 20A to 20D, the highest rating of the cut (cut number “3”) at the relocation destination is also changed (YES in S75). Therefore, the display of the video icon 5 for the cut is changed from the shooting incomplete state to the shooting completion state in step S76 (see FIGS. 20A and 20C).

On the other hand, when determining that the highest rating does not change in the cut at the relocation destination/relocation source (NO in S 75), the controller 210 proceeds to the cut relocation processing step S77 without performing the processing of step S76, for example.

Next, the controller 210 stores the cut allocation data D1 of the update result by the cut relocation processing (S55) as described above in the memory 220 (S77). Thereafter, the controller 210 ends the cut relocation processing (S55), and returns to step S51 in FIG. 16, for example. In this way, in subsequent step S51, the video management screen (FIGS. 20C and 20D) updated by the cut relocation processing (S55) is displayed.

According to the above cut relocation processing (S55), in the information support terminal 200 of the present embodiment, the user can change the cut associated with the video upon shooting, at any timing after shooting using the video management screen, for example.

According to the cut relocation processing (S55) of the present embodiment, the shooting completion state is updated according to the change in the highest rating of the cut of the relocation source/relocation destination (S75 to S76). As a result, the present system 10 can appropriately correct the identification display of the shooting completion state of the cut of the relocation source/relocation destination by eliminating a problem that an error occurs in the identification display of the shooting completion state for each cut due to the rating of the video with a cut error, for example (FIGS. 20A to 20D). In this way, it is possible to accurately manage the shooting completion state for each cut in the present system 10 and to easily suppress forgetting to shoot for each cut.

In the above description, an example of the selection operation of the relocation target in step S71 has been described, but the present system 10 is not particularly limited thereto. For example, in step S71, the display of the check box 5a may be omitted. For example, the controller 210 may receive the selection operation of the relocation target for each video, and may receive the drag and drop operation for each video. In such a case, the selection operation of the relocation target (S71) and the selection operation of the relocation destination (S72) may be integrally input. In the present system 10, the selection operation of the relocation destination (S72) is not particularly limited to the drag and drop operation, and may be various operations for selecting a cut at the relocation destination.

In step S75, the controller 210 may proceed to “KEEP” when the highest rating changes between “OK” and “YES”. For example, the present system 10 may adopt different display modes between a case where the highest rating is “OK” and a case where the highest rating is “KEEP” as the identification display of the shooting completion state.

### 2.3. Export Function

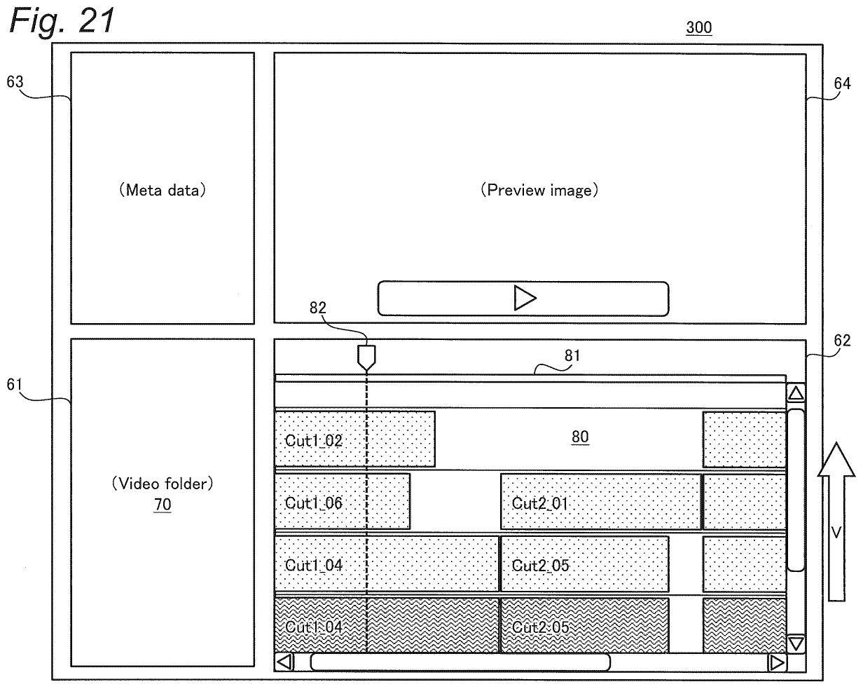

An outline of the export function in the information support terminal 200 of the present system 10 will be described with reference to FIG. 21.

FIG. 21 illustrates a display example of a video editing screen in the video editing PC 300 of the present system 10. For example, the video editing PC 300 (FIG. 1) reads management data as the output of the export function by the information support terminal 200 and video data of an shooting result by the digital camera 100 into predetermined editing software, to display a video editing screen as illustrated in FIG. 21. The editing software may be a variety of non-linear editing (NLE) software, such as Da Vinci Resolve, Adobe Premix Pro, Final Cut Pro, or Vegas Pro.

The video editing screen illustrated in FIG. 21 includes a material display field 61, a timeline editing field 62, a metadata display field 63, and a preview image 64. The video editing screen is a screen for the user to perform various video editing operations. The material display field 61 displays a list of video data (i.e., video materials) read as a material for video editing in the video editing PC 300. In the present system 10, the material display field 61 displays a video folder 70 that is a folder that manages the video material for each cut, for example.

As illustrated in FIG. 21, the video folder 70 includes a cut folder 71 that is a folder for each cut, and a KEEP folder 72 and an OK folder 73 that are provided in each cut folder 71, for example. The KEEP folder 72 stores a video file having a rating “KEEP” in the video material of the cut. The OK folder 73 stores a video file having a rating “OK” in the video material of the cut. In the export function of this system 10, a directory structure for realizing the configuration of the video folder 70 is automatically described in the management data by the controller 210.

The timeline editing field 62 displays a video timeline 80 including a plurality of video materials arranged on a time axis 81, and responds a user operation to edit a video work combining the video materials in the video timeline 80. The video timeline 80 has a track for each row in which video materials are arranged along the time axis 81. In the video timeline 80, the plurality of tracks are arranged in a direction V intersecting the time axis 81, and different video materials can be arranged at the same position on the time axis 81.

A video timeline 80 includes video tracks corresponding to a preset number of tracks and audio tracks respectively corresponding to the video tracks, for example. The video track includes a video clip indicating a video in the video file for each cut. The audio track includes an audio clip indicating audio in the video file for each cut.

The metadata display field 63 displays metadata of the video material displayed in the material display field 61 or the timeline editing field 62. The preview image 64 displays an image in the video material at a timing corresponding to the position of the playback head 82 arranged on the time axis 81 in the video timeline 80.

For example, on the video editing screen (FIG. 21), the user can adjust the arrangement of the video material in the timeline editing field 62, or arrange a new video material in the material display field 61 in the video timeline 80 while checking the preview image 64. By such a user operation, an editing operation of a video work is performed in the present system 10.

The information support terminal 200 according to the present embodiment generates management data for systematically managing a video material so as to reflect cut allocation and the user rating in the export function in view of facilitating the user to perform then editing operation of the video work as described above after executing the cut shooting function, for example. According to the present system 10, the video editing process by the user can be easily performed, and the processing efficiency of the process by the video editing PC 300 can also be improved.

In such an export function, when a cut error occurs at the time of video shooting for each cut before the execution, a problem that video materials are not arranged as intended by the user may occur in the video folder 70 or the video timeline 80. On the other hand, according to the cut relocation processing (S55) of the present embodiment, it is possible to eliminate a cut error that causes a problem before the execution of the export function, and it is easy to realize the information support according to the user's intention in the video folder 70 or the video timeline 80.

### 3. Review

As described above, in the present embodiment, the information support terminal 200 as an example of an electronic device manages video shooting in a scenario including a plurality of cuts. The information support terminal 200 includes a display 240 that displays information, a user interface 230 as an example of an input interface that inputs an operation of a user, and a controller 210 that controls the display 240 according to the operation input on the user interface 230. After the video associated with a first cut of the plurality of cuts is shot, the controller 210 changes the cut to be associated with the shot video to a second cut different from the first cut according to a user operation on the input interface (see FIGS. 19 and 20).

According to the information support terminal 200 described above, the association can be changed from the first cut erroneously associated with the video by the user to the second video intended by the user, for example. According to the information support terminal 200 of the present embodiment, the user can eliminate the cut error of the video in this manner, and it is possible to reduce the management error using the plurality of cuts in the video shooting.

In the information support terminal 200 according to the present embodiment, the controller causes the display 240 to display the video list 50 as an example of a first list indicating a video associated with the first cut, and receives, from the video list 50, a user operation of selecting a video whose cut to be associated with is to be changed by the user interface 230 (see S71, FIG. 20A). As a result, the user can select a video of a desired relocation target from the video list 50, and can easily reduce management errors such as cut errors.

In the information support terminal 200 of the present embodiment, the controller 210 causes the display 240 to display the cut list 51 as an example of a second list indicating a plurality of cuts together with the video list 50 (see FIGS. 20A to 20D). The controller 210 receives a user operation of selecting the second cut as the cut at the relocation destination from the cut list 51 by the user interface 230 (see S72, FIG. 20B), and changes the cut to be associated with the video selected from the first list to the second cut (see S73 to S74, FIGS. 20C and 20D). As a result, the user can select an appropriate cut as the relocation destination from the cut list 51, and it is possible to easily reduce management errors such as cut errors.

In the information support terminal 200 of the present embodiment, the video list 50 lists images such as thumbnail images indicating shooting results for each video associated with individual cuts by the video icons 5, as illustrated in FIG. 18B, for example. For example, as illustrated in FIG. 18A, the cut list 51 lists subject information related to a subject set for each cut, such as a composition of a storyboard, by the cut icons 51a. The user of the present system 10 can easily confirm and correct the cut error from each of the lists 50 and 51.

In the information support terminal 200 of the present embodiment, the controller 210 causes the display 240 to display a cut selection screen (FIG. 7) as an example of a selection screen including a plurality of cuts before video shooting, and receives a user operation of selecting a specific cut from the plurality of cuts on the user interface 230 (S1 to S3). When a video associated with a specific cut is shot, the controller 210 causes the display 240 to display a rating screen (FIG. 9) as an example of an evaluation screen prompting evaluation of the video, and acquires rating information indicating an evaluation of a user of the video from the user interface 230 (S32 to S35).

According to the information support terminal 200 described above, when a video of a take associated with a specific cut selected by the user is shot, the evaluation of the user for the video of the take is acquired, so that video shooting in a scenario including a plurality of cuts can be easily managed.

In the information support terminal 200 of the present embodiment, the controller 210 sets the cut list 30 on the cut selection screen according to the acquired rating information so as to identify whether or not video shooting of a specific cut associated with a video whose rating information indicates the evaluation of the user has been completed (see S5, S1, FIG. 7). As a result, whether or not the video shooting has been completed for each cut is viewed to the user on the cut selection screen, and it is possible to suppress the user forgetting to shoot the video.

In the information support terminal 200 of the present embodiment, when the cut to be associated with the shot video is changed from e.g. the first cut to the second cut, the controller 210 updates the cut allocation data D1 and thus the selection screen according to the rating information of the video associated with each cut after the change (S75 to S77). As a result, it is possible to correct the management of the image shooting completion state by eliminating the cut error and to improve the accuracy of prevention of forgetting the video shooting.

In the information support terminal 200 of the present embodiment, when the rating information for all the videos associated with the specific cut indicates the evaluation “NG” as an example of the first evaluation, the controller 210 identifies that the video shooting of the specific cut has not been completed (YES in S36, NO in S13, S15). When the rating information for at least one video associated with the specific cut indicates the evaluation “OK” or “KEEP” as an example of the second evaluation different from the evaluation “NG”, the controller 210 identifies that the video shooting of the specific cut has been completed (NO in S36, YES in S13, S14). As a result, the cut associated with only the video of the take evaluated as “NG” by the user can be identified as video shooting not being completed, and the completion of video shooting can be easily managed according to the user's intention.

In the information support terminal 200 of the present embodiment, the controller 210 has a playback mode in which a shot video is reproduced and displayed on the display 240 (see FIG. 17). The controller 210 changes the cut to be associated with the shot video according to the user operation on the user interface 230 in the playback mode (see FIG. 16). As a result, when the user of the present system 10 confirms the video in the playback mode, if the user finds a video with a cut error, the user can correct the cut error, and it is possible to easily reduce management errors such as cut errors.

In the information support terminal 200 of the present embodiment, the controller 210 receives a user operation of selecting a shooting location of video shooting on the user interface 230 (see FIG. 11), and updates the cut selection screen so as to narrow down a plurality of cuts according to the selected shooting location (S7, S1). As a result, the user can use the cut selection screen by narrowing down to a desired shooting location, and can easily manage video shooting.

In the information support terminal 200 of the present embodiment, the controller 210 receives an operation of providing an additional cut from a plurality of cuts in the scenario by the user interface 230, and updates the cut selection screen to include the additional cut (see S8, S1, FIG. 12). As a result, the user can use the cut selection screen by adding a cut outside the scenario, and can easily use the cut shooting function.

In the present embodiment, the information support terminal 200 further includes the memory 220 that stores the cut allocation data D1 as an example of management information for managing a video associated with each of a plurality of cuts in a scenario. The controller 210 updates the management information so as to change the cut to be associated with the shot video according to the user operation on the user interface 230 (S71 to S77). In this way, the information support terminal 200 of the present embodiment can reduce management errors using a plurality of cuts in video shooting.

In the present embodiment, the information support terminal 200 further includes the communication interface 250 that performs data communication with the digital camera 100, which is an example of an imaging apparatus that executes video shooting. The controller 210 manages the video shot with the digital camera 100 by data communication via the communication interface 250 (S5). As a result, the information support terminal 200 separate from the digital camera 100 can easily manage the video shooting for each cut.

In the present embodiment, a video management method for managing video shooting including a plurality of cuts is provided. The method includes a step (S56) of controlling, by the controller 210 of the information support terminal 200, shooting of a video in association with the first cut of a plurality of cuts, and a step (S55) of, after the video associated with the first cut is shot, changing the cut to be associated with the shot video to the second cut different from the first cut according to a user operation on the user interface 230.

In the present embodiment, a program for causing the controller 210 to execute the video management method described above is provided. According to such a video management method, it is possible to reduce management errors using a plurality of cuts in video shooting. The controller 210 may control the display 240 that displays information related to video shooting including a plurality of cuts according to an operation input on the user interface 230 to which an operation of a user is input.

### Second Embodiment

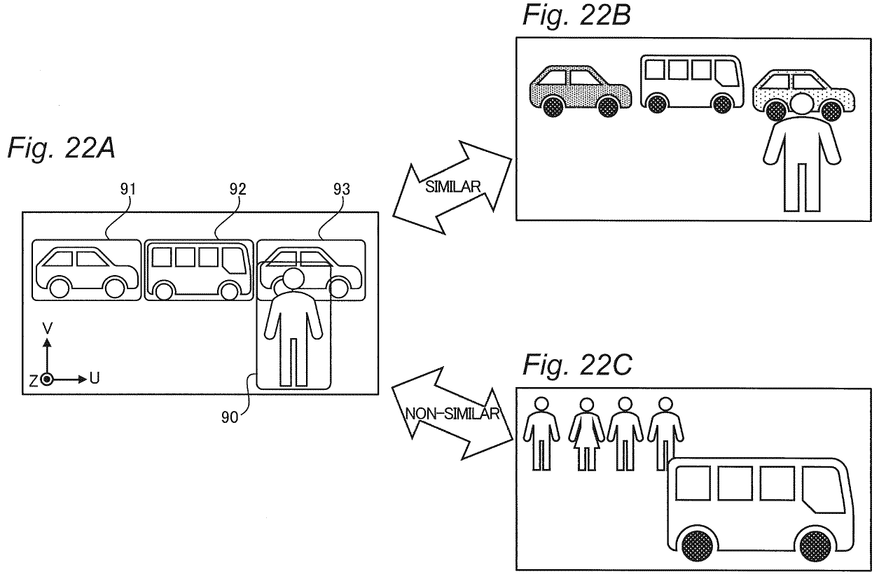

Hereinafter, a second embodiment of the present disclosure will be described with reference to FIGS. 22A to 24. In the first embodiment, an imaging system 10 has been described that performs cut relocation processing on a video with a cut error found by a user. In the second embodiment, an imaging system 10 that automatically detects a video predicted to be a cut error will be described.

Hereinafter, description of configurations and operations similar to those of the imaging system 10 and the information support terminal 200 according to the first embodiment will be omitted as appropriate, and the imaging system 10 and the information support terminal 200 according to the present embodiment will be described.

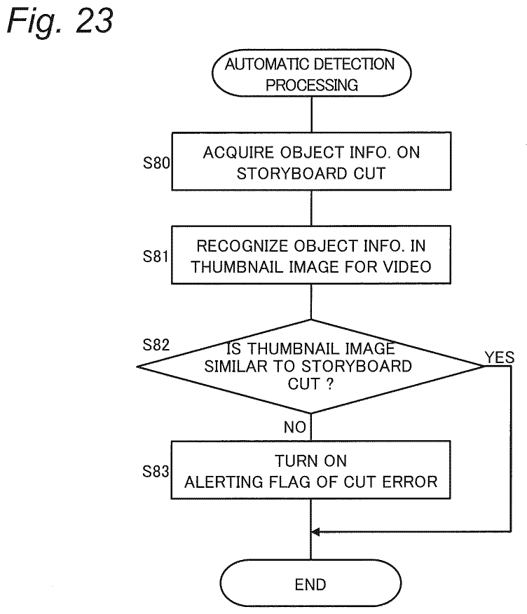

FIG. 23 is a diagram for explaining automatic detection processing in the imaging system 10 of the second embodiment. In performing an operation similar to that of the imaging system 10 of the first embodiment, the present system 10 compares a storyboard for each cut with each video by image recognition, and automatically detects a video with a cut error, for example.

FIG. 23 is a flowchart illustrating automatic detection processing in the imaging system 10 of the second embodiment. The processing illustrated in the flow of FIG. 23 is executed by a controller 210 of the information support terminal 200, for example. For example, the processing of this flow is started after the processing of the recording mode (S56) similar to that of the first embodiment is performed, and the video of the take shot in the recording mode is performed as a detection target.

First, the controller 210 of the information support terminal 200 acquires object information on the storyboard for the cut associated with the video to be detected, for example (S80). FIG. 22A illustrates the object information of such a storyboard.

In the example of FIG. 22A, the storyboard of the cut includes one object 90 of the type “person” and a plurality of objects 91 to 93 of another type “car” arranged behind the object 90. The object information in the example of FIG. 22A includes the number and positional relation of such objects 90 to 93 for each type. For example, the object information of the storyboard is set at the time of inputting the storyboard of the cut in the scenario creation function of the present system 10, stored in the memory 220, and read in step S80.

For example, the controller 210 recognizes the object information in the video, based on a thumbnail image of the video to be detected (S81). The thumbnail images in step S81 are illustrated in FIGS. 22B and 22C.

FIG. 22B illustrates a thumbnail image of a video correctly associated with the cut of FIG. 22A. FIG. 22C illustrates a thumbnail image of a video mistakenly associated with the cut of FIG. 22A.

For example, in step S81, the controller 210 performs image recognition processing using an image recognition AI obtained in advance by machine learning on the thumbnail image, and recognizes the number, type, position, and size of subjects in the thumbnail image, the positional relation between the subjects, and the like. The position of the subject may include a position in a depth direction in addition to a two-dimensional position on the thumbnail image. For example, the positional relation in the depth direction can be recognized by the size of the subject in the thumbnail image, the overlap between the subjects, and the like.

For example, from the thumbnail image illustrated in FIG. 22B, object information in which a positional relation and the like of the subjects are similar to those of the objects 90 to 93 of the storyboard in FIG. 22A is recognized (S81). On the other hand, from the thumbnail image illustrated in FIG. 22C, object information different from the objects 90 to 93 of the storyboard in FIG. 22A in the positional relation of the subject and the number of subjects for each type is recognized (S81).

Next, the controller 210 determines whether the storyboard and the thumbnail image are similar to each other, based on the object information of the cut storyboard associated with the video to be detected and the object information recognized from the thumbnail image of the video, for example (S82).

For example, the processing in step S82 is performed using similarity degree indicating a degree of similarity between pieces of object information. For example, in the example of FIG. 22B, a relatively high similarity degree is calculated. On the other hand, in the example of FIG. 22C, a similarity degree lower than that in the case of FIG. 22B is calculated. For example, the controller 210 calculates the similarity degree as described above, and compares the calculated similarity degree with a predetermined threshold (S82). For example, the threshold is set as a reference of a similarity degree that is small enough to be presumed as a cut error, and is equal to or higher than the similarity degree in FIG. 22C and lower than the similarity degree in FIG. 22B, for example.

When determining that the thumbnail image of the video to be detected is not similar to the storyboard of the cut associated with the video (NO in S82), the controller 210 detects the video as an alerting target for a cut error, and sets an alert flag to ON, for example (S83).

For example, in the example of FIG. 22C, as the similarity degree is equal to or less than the threshold, the controller 210 proceeds to NO in step S82. For example, the alert flag in step S83 is managed for each shot video file, and ON/OFF indicates whether or not the video is an alerting target of a cut error. For example, the alert flag is managed in the memory 220 with an initial value set to OFF.

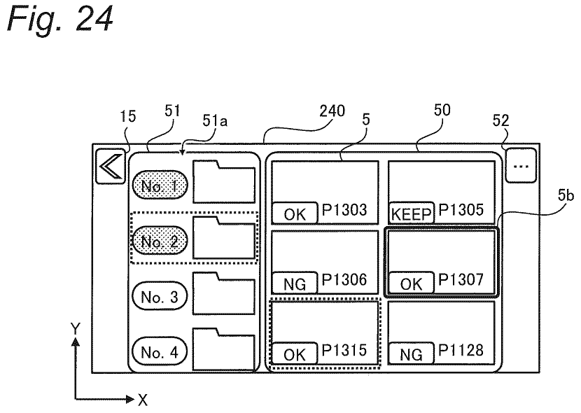

When the alert flag is set to ON as the detection result of the cut error (S83), the controller 210 ends the automatic detection processing illustrated in FIG. 23. FIG. 24 illustrates a display example of the information support terminal 200 when the alert flag is set to ON in this way.

On the other hand, when determining that the storyboard and the thumbnail image are similar to each other (YES in S82), the controller 210 does not particularly detect the video as an alerting target of a cut error, and ends the automatic detection processing of FIG. 23. For example, in the example of FIG. 22B, as the similarity degree is larger than the threshold, the controller 210 proceeds to YES in step S82. In this case, the alert flag of the video is maintained at OFF.

According to the automatic detection processing (FIG. 23) in the present system 10 described above, as exemplified in FIGS. 22A to 22C, an alerting target of a cut error can be detected on the basis of whether or not a storyboard of the cut and a thumbnail image associated with a video are similar to each other (S82 to S83).

The information support terminal 200 of the present embodiment notifies the user of the detected video of the alerting target on the video management screen after the automatic detection processing (FIG. 23), as exemplified in FIG. 24. In the present embodiment, when performing the playback mode processing similar to that of the first embodiment, referring to the alert flag in step S51 in FIG. 16, the controller 210 of the information support terminal 200 adds an emphasized display 5b such as a frame enclosure to the video icon 5 in which the alert flag is in the ON state, for example.

Thus, the user of the present system 10 can confirm a video having a possibility of a cut error on the video management screen of FIG. 24, and can consider whether or not to perform the cut relocation processing, for example. When the cut relocation processing is performed on the video that is an alerting target, the controller 210 returns the alert flag for the video to OFF, for example.

In the above description, an example in which the automatic detection processing is executed after the processing of the recording mode has been described. The automatic detection processing of the present embodiment is not particularly limited thereto, and may be performed in the playback mode, for example. For example, after the cut relocation processing in the playback mode, the controller 210 may perform the automatic detection processing on the cut at the relocation destination (or the relocation source).

In the present embodiment, the automatic detection processing may be performed for videos of a plurality of takes, or the automatic detection processing may be performed for a plurality of cuts. For example, when a video with a cut error is detected, the controller 210 may automatically detect a cut predicted to be a relocation destination of the video. Such automatic detection can be performed similarly to the automatic detection processing described above by comparing object information of various cuts with object information of a video with a cut error, for example.

In step S50 described above, the object information of the cut may not be stored in the memory 220 in advance, and for example, the controller 210 may acquire the object information by performing image recognition on the image information of the storyboard. In step S51 described above, the input of the image recognition is not limited to the thumbnail image of the video, and may be various images in the video.

The automatic detection processing of the present embodiment is not limited to the comparison of the object information, and may be performed by similarity determination by various types of image recognition. The controller 210 of the information support terminal 200 may detect the video with a cut error by transmitting the video to be compared and the information related to the cut to an external server and receiving the image recognition result as a response.

As described above, in the information support terminal 200 according to the present embodiment, the controller 210 detects a video in which the cut to be associated with is to be changed from the first cut, based on the result (S81) of the image recognition of the subject in the video associated with the first cut and the subject information (S80) related to the subject set to the first cut (S82 to S83). As a result, the information support terminal 200 of the present embodiment can automatically detect the video with a cut error and easily reduce the management error.

In the information support terminal 200 of the present embodiment, when detecting a video in which the cut to be associated with is to be changed from the first cut (YES in S83), the controller 210 notifies the user of the detected video (S84). For example, as illustrated in FIG. 24, the controller 210 may control the display 240 so as to notify the user of the detected video. Thus, the user of the present system 10 can consider whether or not to perform the cut relocation of the detected video, and can easily reduce the management error according to the user's intention.

### OTHER EMBODIMENTS

As described above, the first and second embodiments have been described as an example of the technology disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment.

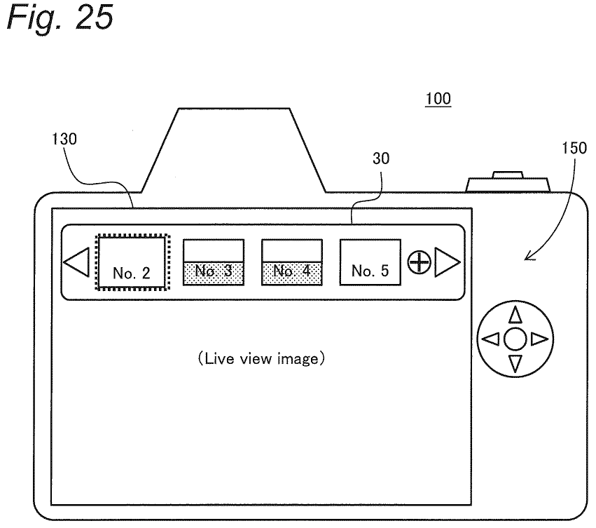

In the first and second embodiments described above, the information support terminal 200 has been described as an example of an electronic device different from the imaging apparatus, but the present disclosure is not limited thereto. The electronic device according to the present embodiment may be integrated with an imaging apparatus that performs video shooting. Such a modification will be described with reference to FIG. 25.

FIG. 25 illustrates a modification of the digital camera 100. In the present embodiment, the digital camera 100 has various functions such as the above-described cut shooting function of the information support terminal 200. For example, as illustrated in FIG. 25, the controller 135 of the digital camera 100 displays a cut selection screen including a plurality of cuts by the cut list 30 on the display monitor 130, and receives the cut selection by the user through the user interface 150 such as a touch panel or an operation button.

In the example of FIG. 25, the display monitor 130 superimposes and displays the cut list 30 on the live view image. The controller 135 of the digital camera 100 generates video data by an imaging operation of the image sensor 115, for example. When a video of the selected cut is shot, the controller 135 of the digital camera 100 displays a rating screen (FIG. 9) on the display monitor 130 to acquire rating information of the user, similarly to the recording mode processing of the first embodiment (FIG. 13). Similarly to the first embodiment, the digital camera 100 can also provide the user with the information support by the cut shooting function and the export function.

As described above, in the present embodiment, the digital camera 100 as an example of an electronic device further includes the image sensor 115 as an example of an image sensor that captures a subject image and generates image data. The controller 135 manages a video including image data generated by the image sensor 115. Consequently, the digital camera 100 can easily manage the video shooting for each cut. The electric device is not limited to the digital camera 100, and may be various information terminals. For example, the information support terminal 200 may include an image sensor 115, and may manage the shooting result by the image sensor 115 similarly to the first and second embodiments.

In the above embodiments, as an example of the first/second cut, the cut at the relocation source/relocation destination is illustrated (FIGS. 20A to 20D). In the present embodiment, each of the first cut and the second cut is not particularly limited to one, and may be a group of a plurality of cuts. For example, in the present system 10, the video being shot may be associated with a group of cuts. Even in this case, the present system 10 can reduce a management error in video shooting including a plurality of cuts by the function of reviewing a cut error similarly to each of the above embodiments.

In the above embodiments, the cut selection screen including the cut list 30 has been exemplified, but the selection screen of the present disclosure is not limited thereto. The selection screen according to the present embodiment may not include the cut list 30, and may include a plurality of cuts in a display mode different from the cut icon 3. In addition, the selection screen according to the present embodiment may be a dialog display, or may be superimposed and displayed on various display screens. In the present embodiment, the cut list 30 may be an example of the selection screen. In the present embodiment, the selection screen of the information support terminal 200 may identify and display whether or not the video shooting has been completed for each cut in various display modes other than the above-described example.

In the above embodiments, three types of examples in which the rating information is “OK”, “KEEP”, and “NG” have been described, but the rating information is not particularly limited thereto. In the present embodiment, the rating information may be three types of rating different from the above, and is not particularly limited to three types, and may be two types or four or more types. In the present embodiment, the rating information may be a score of a continuous value. The electronic device according to the present embodiment may receive a user input of such various types of rating information and manage video shooting for each cut. For example, the identification display can be performed by appropriately providing a criterion as to whether or not the video shooting of the cut is completed.

In the above embodiments, the digital camera 100 including the optical system 110 and the lens driver 112 has been exemplified. The imaging apparatus according to the present embodiment may not particularly include the optical system 110, the lens driver 112, and the like, and may be an interchangeable lens type camera, for example.

In the above embodiments, the digital camera has been described as an example of the imaging apparatus, but the present disclosure is not limited thereto. The imaging apparatus of the present disclosure has only to be an electronic device having an imaging function (e.g., a video camera, a smartphone, a tablet terminal, or the like). The electronic device of the present disclosure does not particularly need to have an image imaging function, and may be various electronic devices.

### ASPECT EXAMPLES

Hereinafter, various aspects of the present disclosure will be exemplified.

A first aspect according to the present disclosure is an electronic device for managing video shooting including a plurality of cuts. The electronic device includes: a display that displays information on the video shooting including the plurality of sections; an input interface that inputs a user operation; and a controller that controls the display according to the user operation input on the input interface. After a video associated with a first section of the plurality of sections is shot, the controller changes an associated section into a second section from the first section, according to the user operation on the input interface, the associated section being associated the shot video, the second section being different from the first section.

In a second aspect, in the electronic device according to the first aspect the controller causes the display to display a first list indicating the video associated with the first section, and causes the input interface to receive the user operation selecting a video with which the associated section is to be changed from the first list.

In a third aspect, in the electronic device according to the second aspect, the controller causes the display to display, with the first list, a second list indicating the plurality of sections, and causes the input interface to receive the user operation selecting the second section from the second list, to change the associated section with the video selected from the first list into the second section.

In the electronic device according to the second or third aspect, the first list may list images indicating shooting results for each video associated with the first section. In the electronic device according to the third aspect, the second list may list subject information related to a subject set for each section.

In a fourth aspect, in the electronic device according to any one of the first to third aspects, the controller detects a target video, based on a result of image recognition of a subject in the associated video with the first section and subject information on a subject set to the first section, the target video being a target for changing the associated section therewith from the first section.

In the electronic device according to the fourth aspect, the controller may control the display to notify a user of a detected vide when detecting the vide in which a cut to be associated with is to be changed from the first cut.

In a fifth aspect, in the electronic device according to any one of the first to fourth aspects, prior to the video shooting, the controller causes the display to display a selection screen to receive the user operation selecting the first section from the plurality of sections on the input interface, the selection screen including the plurality of sections. When the video associated with the first section is shot, the controller acquires rating information from the input interface, the rating information indicating a rating of a user for the video.

In a sixth aspect, in the electronic device according to the fifth aspect, the controller sets the selection screen to identify whether or not the video shooting of the first section is completed according to the acquired rating information. When the associated section with the shot video is changed, the controller updates the selection screen according to the rating information on the video associated with each section after the change.

In a seventh aspect, in the electronic device according to any one of the first to sixth aspects, the controller has a playback mode to play the shot video on the display. The controller changes the associated section with the shot video, according to the user operation on the input interface in the playback mode.

In an eighth aspect, the electronic device according to any one of the first to seventh aspects further includes a memory that stores management information for managing the video associated with each of the plurality of sections. The controller updates the management information to change the associated section with the shot video according to the user operation on the input interface.

In a ninth aspect, the electronic device according to any one of the first to eighth aspects further includes a communication interface that communicates data with an imaging apparatus for shooting the video. The controller manages the video shot with the imaging apparatus by data communication via the communication interface.

In a tenth aspect, the electronic device according to any one of the first to ninth aspects further includes an image sensor that captures a subject image to generate image data. The controller manages the video including the image data generated by the image sensor.

An eleventh is a video management method for managing video shooting including a plurality of sections. The video management method includes: controlling, by a controller of an electronic device, shooting of a video in association with a first section of the plurality of sections; and changing, by the controller, an associated section into a second section from the first section according to a user operation on an input interface, after the video associated with the first section is shot, the associated section being associated the shot video, the second section being different from the first section.

A twelfth aspect is a non-transitory computer-readable recording medium storing a program for causing the controller to execute the video management method according to the eleventh aspect.

As described above, the embodiments have been described as an example of the technology in the present disclosure. For this purpose, the accompanying drawings and the detailed description have been provided. Accordingly, some of the components described in the accompanying drawings and the detailed description may include not only essential components for solving the problem but also components which are not essential for solving the problem in order to describe the above technology.

The present disclosure is applicable to various uses for shooting a video including a plurality of cuts.

1. An electronic device for managing video shooting including a plurality of sections, the electronic device comprising:
a display that displays information on the video shooting including the plurality of sections;
an input interface that inputs a user operation; and
a controller that controls the display according to the user operation input on the input interface,
wherein after a video associated with a first section of the plurality of sections is shot, the controller changes an associated section into a second section from the first section, according to the user operation on the input interface, the associated section being associated the shot video, the second section being different from the first section.

2. The electronic device according to claim 1, wherein the controller
causes the display to display a first list indicating the video associated with the first section, and
causes the input interface to receive the user operation selecting a video with which the associated section is to be changed from the first list.

3. The electronic device according to claim 2, the controller
causes the display to display, with the first list, a second list indicating the plurality of sections, and
causes the input interface to receive the user operation selecting the second section from the second list, to change the associated section with the video selected from the first list into the second section.

4. The electronic device according to claim 1, wherein the controller detects a target video, based on a result of image recognition of a subject in the associated video with the first section and subject information on a subject set to the first section, the target video being a target for changing the associated section therewith from the first section.

5. The electronic device according to claim 1, wherein
prior to the video shooting, the controller causes the display to display a selection screen to receive the user operation selecting the first section from the plurality of sections on the input interface, the selection screen including the plurality of sections, and
when the video associated with the first section is shot, the controller acquires rating information from the input interface, the rating information indicating a rating of a user for the video.

6. The electronic device according to claim 5, wherein
the controller sets the selection screen to identify whether or not the video shooting of the first section is completed according to the acquired rating information, and
when the associated section with the shot video is changed, the controller updates the selection screen according to the rating information on the video associated with each section after the change.

7. The electronic device according to claim 1, wherein
the controller has a playback mode to play the shot video on the display, and
the controller changes the associated section with the shot video, according to the user operation on the input interface in the playback mode.

8. The electronic device according to claim 1,
further comprising a memory that stores management information for managing the video associated with each of the plurality of sections,
wherein the controller updates the management information to change the associated section with the shot video according to the user operation on the input interface.

9. The electronic device according to claim 1,
further comprising a communication interface that communicates data with an imaging apparatus for shooting the video,
wherein the controller manages the video shot with the imaging apparatus by data communication via the communication interface.

10. The electronic device according to claim 1,
further comprising an image sensor that captures a subject image to generate image data,
wherein the controller manages the video including the image data generated by the image sensor.

11. A video management method for managing video shooting including a plurality of sections, the video management method comprising:
controlling, by a controller of an electronic device, shooting of a video in association with a first section of the plurality of sections; and
changing, by the controller, an associated section into a second section from the first section according to a user operation on an input interface, after the video associated with the first section is shot, the associated section being associated the shot video, the second section being different from the first section.

12. A non-transitory computer-readable recording medium storing a program for causing the controller to execute the video management method according to claim 11.
